(19) United States
(12) Patent Application Publication
(10) Pub. No.: US 2023/0307169 A1
(43) Pub. Date: Sep. 28, 2023

(54) REACTOR, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kohei YOSHIKAWA, Mie (JP); Naotoshi FURUKAWA, Mie (JP); Seiji SHITAMA, Mie (JP)

(21) Appl. No.: 18/021,086

(22) PCT Filed: Jul. 28, 2021
(86) PCT No.: PCT/JP2021/027950

§ 371 Date: Feb. 13, 2023

(30) Foreign Application Priority Data
Aug. 19, 2020 (JP) 2020-138584

(51) Int. Cl. H01F 27/24; H01F 37/00; H01F 1/20; H01F 27/30; H01F 27/02

(52) U.S. Cl. CPC H01F 27/24; H01F 37/00; H01F 1/20; H01F 27/306; H01F 27/022

(57) ABSTRACT

A reactor is provided with a coil and a magnetic core. The magnetic core has a first surface made of a material mainly containing a magnetic material, and a second surface facing the first surface. The first surface has a first region with a surface property following that of the second surface.

### TECHNICAL FIELD

The present disclosure relates to a reactor, a converter, and a power conversion device.

This application claims a priority based on Japanese Patent Application No. 2020-138584 filed on Aug. 19, 2020, all the contents of which are hereby incorporated by reference.

### BACKGROUND

A reactor of patent document 1 is provided with a coil and a magnetic core. The coil includes a pair of coil elements. The magnetic core is configured by combining a plurality of divided core pieces.

### PRIOR ART DOCUMENT

### Patent Document

Patent Document 1: JP 2014-146656 A

### SUMMARY OF THE INVENTION

A reactor according to the present disclosure includes a coil and a magnetic core, the magnetic core having a first surface made of a material mainly containing a magnetic material and a second surface facing the first surface, the first surface having a first region with a surface property following that of the second surface.

A converter of the present disclosure includes the reactor of the present disclosure.

A power conversion device of the present disclosure includes the converter of the present disclosure.

### BRIEF DESCRIPTION OF THE DRAWINGS

FIG. 1 is a perspective view showing an outline of an entire reactor according to a first embodiment.

FIG. 2 is a top view showing the outline of the entire reactor according to the first embodiment.

FIG. 3 is an enlarged view showing an outline of a region surrounded by a broken-line circle shown in FIG. 2.

FIG. 4 is an enlarged view showing an outline of another example of the region surrounded by the broken line circle shown in FIG. 2.

FIG. 5 is an enlarged view showing an outline of a region surrounded by a one-dot chain line circle shown in FIG. 2.

FIG. 6 is a view showing a reactor manufacturing method for manufacturing the reactor according to the first embodiment.

FIG. 7 is a view showing another example of the reactor manufacturing method for manufacturing the reactor according to the first embodiment.

FIG. 8 is a top view showing an outline of an entire reactor according to a second embodiment.

FIG. 9 is a top view showing an outline of an entire reactor according to a third embodiment.

FIG. 10 is a top view showing an outline of an entire reactor according to a fourth embodiment.

FIG. 11 is a top view showing an outline of an entire reactor according to a fifth embodiment.

FIG. 12 is an enlarged view showing an outline of a region surrounded by a broken-line circle shown in FIG. 11.

FIG. 13 is an enlarged view showing an outline of another example of the region surrounded by the broken line circle shown in FIG. 11.

FIG. 14 is a top view showing an outline of an entire reactor according to a sixth embodiment.

FIG. 15 is a top view showing an outline of an entire reactor according to a seventh embodiment.

FIG. 16 is a top view showing an outline of an entire reactor according to an eighth embodiment.

FIG. 17 is a top view showing an outline of an entire reactor according to a ninth embodiment.

FIG. 18 is a top view showing an outline of an entire reactor according to a tenth embodiment.

FIG. 19 is a configuration diagram schematically showing a power supply system of a hybrid vehicle.

FIG. 20 is a circuit diagram showing an outline of an example of a power conversion device provided with a converter.

### DETAILED DESCRIPTION TO EXECUTE THE INVENTION

### Technical Problem

In combining the plurality of core pieces, the core pieces may not be accurately combined due to dimensional tolerances of the core pieces and an unnecessary interval may be provided between the core pieces. A desired inductance may not be obtained due to this unnecessary interval.

One object of the present disclosure is to provide a reactor which easily obtains a desired inductance. Another object of the present disclosure is to provide a converter provided with the above reactor. Still another object of the present disclosure is to provide a power conversion device provided with the above converter.

### Effect of Present Disclosure

The reactor according to the present disclosure easily obtains a desired inductance.

The converter according to the present disclosure and the power conversion device according to the present disclosure are excellent in productivity.

### Description of Embodiments of Present Disclosure

First, embodiments of the present disclosure are listed and described.

(1) A reactor according to one aspect of the present disclosure includes a coil and a magnetic core, the magnetic core having a first surface made of a material mainly containing a magnetic material and a second surface facing the first surface, the first surface having a first region with a surface property following that of the second surface.

The reactor easily obtains a desired inductance. The first region is formed as follows in a reactor manufacturing process to be described in detail later. The first and second surfaces are held in contact. The magnetic core is pressed in directions to bring the first and second surfaces closer. By this pressing, a contact part of the first surface with the second surface is deformed. By this deformation, the first region is formed. By the deformation of the first surface, dimensional tolerances of constituent members of the magnetic core are easily absorbed. Since the constituent members of the magnetic core are accurately combined with ease by absorbing the dimensional tolerances, an unnecessary interval is less likely to be provided between the constituent members of the magnetic core.

(2) As one aspect of the reactor, the first surface has a non-contact region arranged apart from the second surface.

Since a gap can be provided between the first and second surfaces by the non-contact region in the reactor, the inductance is easily adjusted.

(3) As one aspect of the reactor, the first surface has a contact region in contact with the second surface without having the surface property following that of the second surface.

In the reactor, a contact area of the first and second surfaces can be increased by the contact region as compared to the case where the first surface has no contact region. Thus, the reactor easily enhances thermal conductivity between the first and second surfaces. Therefore, the reactor easily enhances the thermal conductivity of the magnetic core.

(4) As one aspect of the reactor, the second surface is made of a material mainly containing a magnetic material and has a second region with a surface property following that of the first surface.

Since the second surface has the second region, the reactor more easily obtains the desired inductance. The second region is formed by deforming a contact region of the second surface with the first surface by the aforementioned pressing in the reactor manufacturing process. By the deformation of the second surface, the dimensional tolerances of the magnetic core are more easily absorbed. Thus, the constituent members of the magnetic core are accurately combined with more ease and an unnecessary interval is even less likely to be provided between the constituent members of the magnetic core.

(5) As one aspect of the reactor of (4) described above, the coil includes one tubular winding portion, the magnetic core is a set obtained by combining a first core piece and a second core piece in an axial direction of the winding portion, the first core piece is E-shaped, the second core piece is E-shaped, T-shaped, I-shaped or U-shaped, the first surface is provided on the first core piece, and the second surface is provided on the second core piece.

The reactor easily obtains the desired inductance even if a combination of the first and second core pieces is a E-E, E-T, E-I or E-U combination. The reason for that is as follows. Dimensional tolerances of the first and second core pieces are easily absorbed by the first surface of the first core piece and the second surface of the second core piece. Thus, the first and second core pieces are accurately combined with ease. Therefore, an unnecessary interval is less likely to be provided between the first and second core pieces. Further, since the reactor can be constructed by combining the first and second core pieces with the winding portion along the axial direction of the winding portion, manufacturing workability is excellent.

(6) As one aspect of the reactor of (4) described above, the coil includes two tubular winding portions, the two winding portions are so arranged side by side that axial directions are parallel, the magnetic core is a set obtained by combining a first core piece and a second core piece in the axial directions of the winding portions, the first core piece is U-shaped, the second core piece is U-shaped or I-shaped, the first surface is provided on the first core piece, and the second surface is provided on the second core piece.

The reactor easily obtains the desired inductance even if the combination of the first and second core pieces is a U-U or U-I combination. The reactor is excellent in manufacturing workability.

(7) As one aspect of the reactor, the second surface is made of a material mainly containing a non-magnetic material and has a second region with a surface property following that of the first surface.

The reactor easily obtains the desired inductance. The reason for that is as follows. Even if the second surface is made of the material mainly containing the non-magnetic material, the first region can be provided on the first surface by the aforementioned pressing in the reactor manufacturing process. Moreover, the second region can be prevented on the second surface.

(8) As one aspect of the reactor of (7) described above, the coil includes one tubular winding portion, the magnetic core is a set obtained by combining a first core piece and a second core piece to sandwich a gap material from both sides in an axial direction of the winding portion, the first core piece is E-shaped, the second core piece is E-shaped, T-shaped, I-shaped or U-shaped, the first surface is provided on at least one of the first and second core pieces, and the second surface is provided on a surface of the gap material facing the first surface.

The reactor easily obtains the desired inductance even if the combination of the first and second core pieces is a E-E, E-T, E-I or E-U combination and the gap material is interposed between the first and second core pieces. Further, since the reactor can be constructed by combining the first and second core pieces with the winding portion along the axial direction of the winding portion to sandwich the gap material, manufacturing workability is excellent.

(9) As one aspect of the reactor of (7) described above, the coil includes two tubular winding portions, the two winding portions are so arranged side by side that axial directions are parallel, the magnetic core is a set obtained by combining a first core piece and a second core piece to sandwich a gap material from both sides in the axial directions of the winding portions, the first core piece is U-shaped, the second core piece is U-shaped or I-shaped, the first surface is provided on at least one of the first and second core pieces, and the second surface is provided on a surface of the gap material facing the first surface.

The reactor easily obtains the desired inductance even if the combination of the first and second core pieces is the U-U or E-I combination and the gap material is interposed between the first and second core pieces. Further, the reactor is excellent in manufacturing workability.

(10) As one aspect of the reactor of any one of (5), (6), (8) and (9) described above, the first and second core pieces respectively have a third surface and a fourth surface facing each other, and the third and fourth surfaces have regions in contact with each other without each having a surface property following that of the other.

Since a contact area of the first and second core pieces can be increased in the reactor, thermal conductivity between the first and second core pieces is easily enhanced and, eventually, the thermal conductivity of the magnetic core is easily enhanced.

(11) As one aspect of the reactor of any one of (5), (6), (8) to (10) described above, the first core piece is constituted by a compact of a composite material, a soft magnetic powder being dispersed in a resin in the composite material, and the second core piece is constituted by a powder compact containing a soft magnetic powder.

Since the first and second core pieces are made of different materials in the reactor, the inductance is easily adjusted and, moreover, heat dissipation is easily adjusted as compared to the case where the magnetic core is made of a single material.

(12) As one aspect of the reactor of (4) described above, the coil includes at least one tubular winding portion, and the magnetic core is a set obtained by combining three or more core pieces.

The reactor easily obtains the desired inductance even if the magnetic core is a combination of three or more core pieces.

(13) As one aspect of the reactor of (7) described above, the coil includes at least one tubular winding portion, the magnetic core is a set obtained by combining three or more core pieces and a gap material disposed in at least one of gaps between adjacent ones of the core pieces, the first surface is provided on at least one of the core pieces sandwiching the gap material, and the second surface is provided on a surface of the gap material facing the first surface.

The reactor easily obtains the desired inductance even if the magnetic core is a combination of three or more core pieces and the gap material.

(14) As one aspect of the reactor, a molded resin portion is provided which at least partially covers the magnetic core.

The reactor can protect the magnetic core from an external environment. Moreover, the reactor easily ensures insulation between the coil and the magnetic core if the molded resin portion is interposed between the coil and the magnetic core. The core pieces or the coil and the magnetic core are easily positioned with respect to each other in the reactor if the molded resin portion is present between the plurality of core pieces or between the coil and the magnetic core.

(15) A converter according to one aspect of the present disclosure includes the reactor of any one of (1) to (14) described above.

The converter is excellent in productivity since including the reactor in which the magnetic core is accurately combined with ease.

(16) A power conversion device according to one aspect of the present disclosure includes the converter of (15) described above.

The power conversion device is excellent in productivity since including the above converter.

### Details of Embodiments of Present Disclosure

Embodiments of the present disclosure are described in detail below with reference to the drawings. The same reference signs in figures denote the same components.

### First Embodiment

[Reactor]

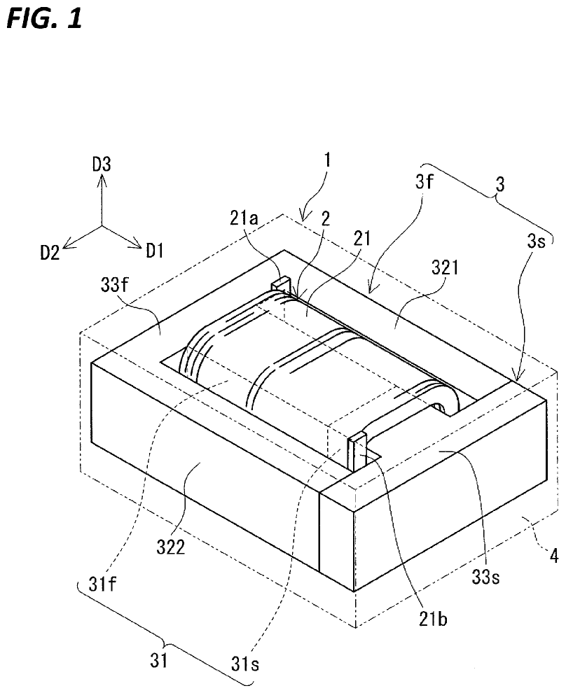

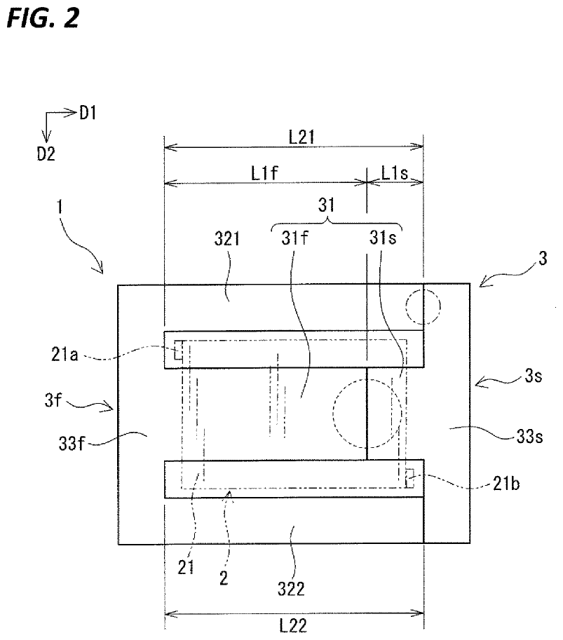

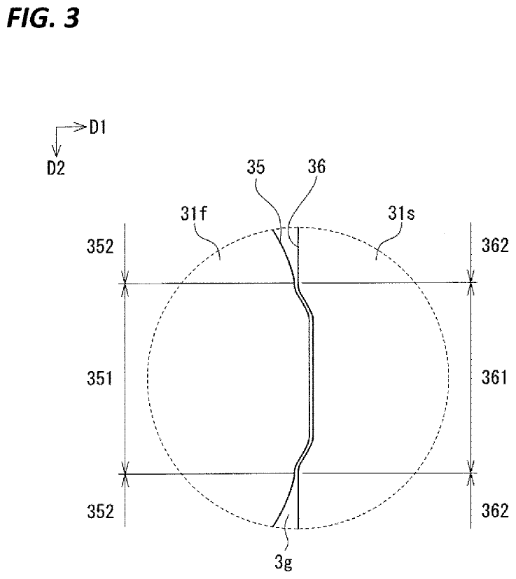

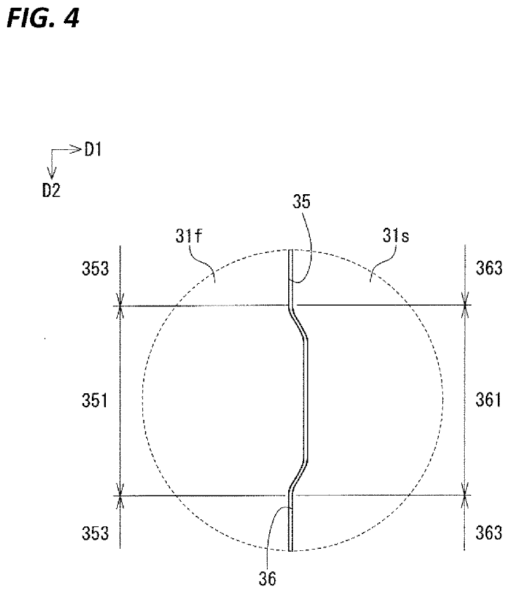

A reactor 1 according to a first embodiment is described with reference to FIGS. 1 to 7. As shown in FIGS. 1 and 2, the reactor 1 includes a coil 2 and a magnetic core 3. One of features of the reactor 1 of this example is that the magnetic core 3 has specific first surface 35 and second surface 36 shown in FIG. 3 or 4. Each component is described in detail below.

[Coil]

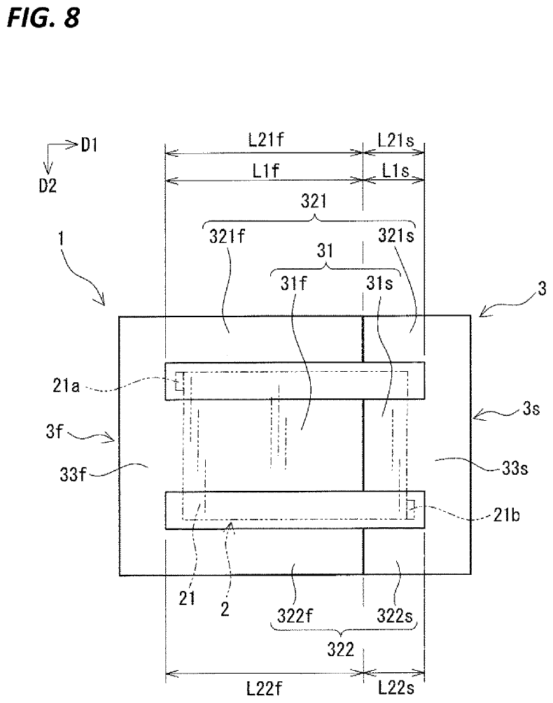

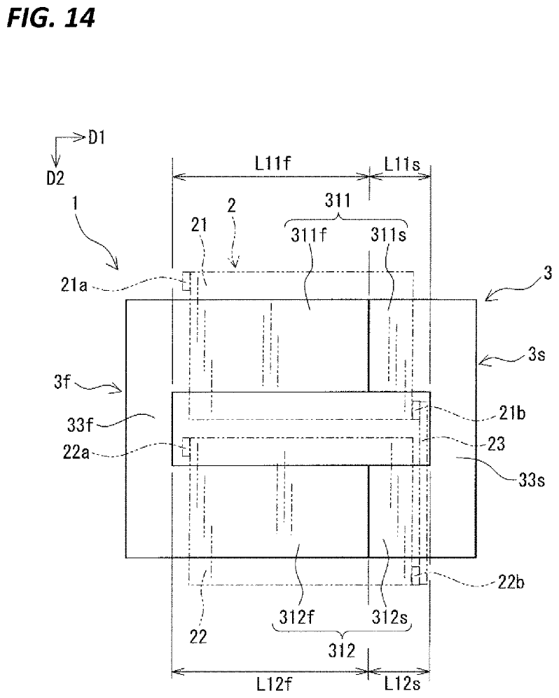

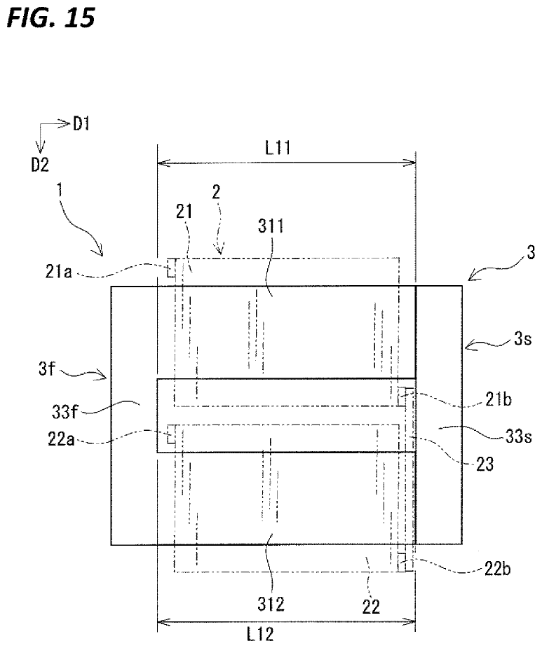

The coil 2 includes at least one winding portion. FIGS. 1 and 2 referred to in this example, and FIGS. 8 to 11 referred to in second to fifth embodiments show an example in which the coil 2 includes one winding portion 21. FIGS. 14 to 18 referred to in sixth to tenth embodiments show an example in which the coil 2 includes two winding portions 21, 22. The coil 2 is shown by a two-dot chain line for the convenience of description in FIGS. 2, 8 to 11 and 14 to 18.

By including one winding portion 21, the reactor 1 of this example can shorten a length along a second direction D2 to be described later as compared to reactors 1 of the sixth to tenth embodiments in which the two winding portions 21, 22 are arranged in parallel in a direction orthogonal to axial directions of the winding portions 21, 22 if the winding portions have the same cross-sectional area and the same number of turns.

The winding portion 21 may have a quadrilateral tube shape or a cylindrical tube shape. Examples of the quadrilateral include squares beside rectangles. The winding portion 21 of this example has a quadrilateral tube shape as shown in FIG. 1. That is, the end surface shape of the winding portion 21 is a quadrilateral frame shape. Since the winding portion 21 has a quadrilateral tube shape, a contact area of the winding portion 21 and an installation target is easily increased as compared to the case where a winding portion has a cylindrical tube shape having the same cross-sectional area. Thus, the reactor 1 easily dissipates heat to the installation target via the winding portion 21. Moreover, the winding portion 21 is easily disposed on the installation target. Corner parts of the winding portion 21 are rounded.

The winding portion 21 of this example is configured by spirally winding one winding wire having no joint part. A known winding wire can be used as the winding wire. A coated rectangular wire is used as the winding wire of this example. A conductor wire of the coated rectangular wire is constituted by a rectangular wire made of copper. An insulation coating of the coated rectangular wire is made of enamel. The winding portion 21 is constituted by an edgewise coil formed by winding the coated rectangular wire in an edgewise manner.

A first end part 21a and a second end part 21b of the winding portion 21 are respectively pulled out to an outer peripheral side of the winding portion 21, in this example, on one and the other end sides in the axial direction of the winding portion 21. Although not shown, the insulation coating is stripped to expose the conductor wire in the first and second end parts 21a, 21b of the winding portion 21. The exposed parts of the conductor wire are pulled out to the outside of a molded resin portion 4 to be described later and terminal members are connected thereto. An external device is connected to the coil 2 via these terminal members. The external device is not shown. A power supply for supplying power to the coil 2 can be cited as the external device.

[Magnetic Core]

The configuration of the magnetic core 3 can be appropriately selected according to the number of the winding portion 21. If the coil 2 includes one winding portion 21 as shown in FIGS. 1 and 2 referred to in this example and FIGS. 8 to 11 referred to in the second to fifth embodiments, the magnetic core 3 includes a middle core piece 31, a first side core piece 321, a second side core piece 322, a first end core piece 33f and a second end core piece 33s. If the coil 2 includes two winding portions 21, 22 as shown in FIGS. 14 to 18 referred to in the sixth to tenth embodiments, the magnetic core 3 includes a first middle core piece 311, a second middle core piece 312, a first end core piece 33f and a second end core piece 33s.

If the coil 2 includes one winding portion 21 as shown in FIGS. 1, 2 and the like, a direction along the axial direction of the winding portion 21 is a first direction D1, a parallel direction of the middle core piece 31, the first side core piece 321 and the second side core piece 322 is the second direction D2 and a direction orthogonal to both the first and second directions D1, D2 is a third direction D3 in the magnetic core 3. The first, second and third directions D1, D2 and D3 when the coil 2 includes two winding portions 21, 22 as shown in FIGS. 14 to 18 are described later.

(Middle Core Piece)

The middle core piece 31 has a part to be arranged inside the winding portion 21. The shape of the middle core piece 31 is, for example, a shape corresponding to the inner peripheral shape of the winding portion 21 and, in this example, a rectangular column shape as shown in FIG. 1. Corner parts of the middle core piece 31 may be rounded to extend along the inner peripheral surfaces of the corner parts of the winding portion 21.

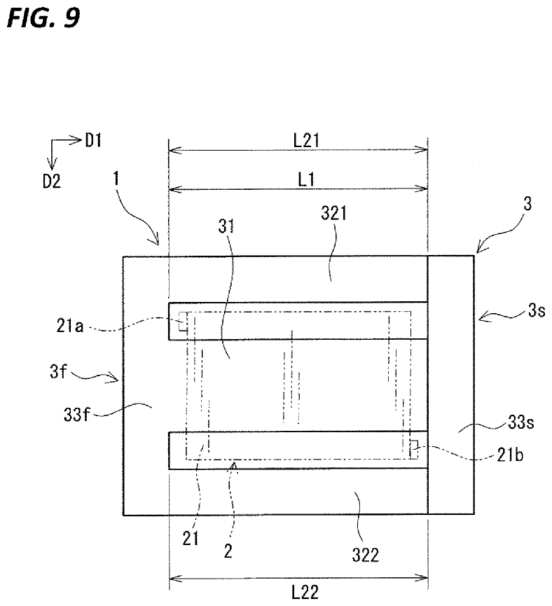

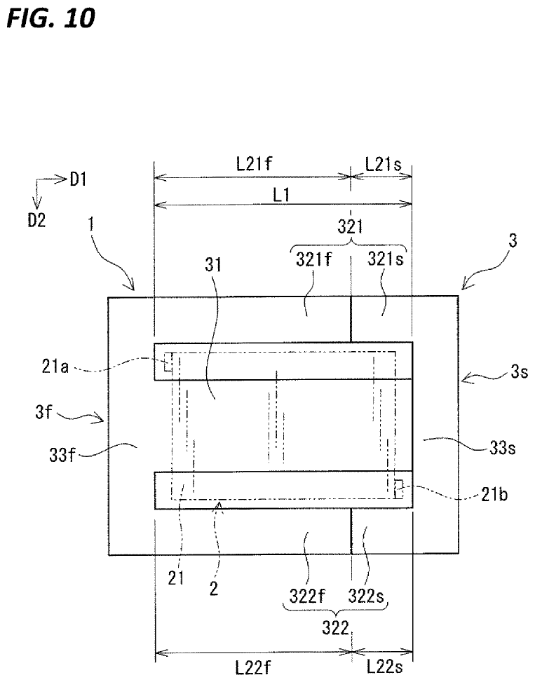

The middle core piece 31 is, for example, composed of two core parts including a first middle core part 31f and a second middle core part 31s as in this example shown in FIGS. 1 and 2 and the second embodiment shown in FIG. 8. Further, the middle core piece 31 may be composed of one core part as in the third and fourth embodiments shown in FIGS. 9 and 10.

A length of the middle core piece 31 along the first direction D1 is longer than that of the winding portion 21 along the axial direction as shown in FIG. 2. Unlike this example, the length of the middle core piece 31 along the first direction D1 and that of the winding portion 21 along the axial direction may be equal. The length of the middle core piece 31 along the first direction D1 is the sum (L1f+L1s) of a length L1f of the later-described first middle core part 31f and a length L1s of the later-described second middle core part 31s. If a gap material 3g to be described later is interposed, the length of the middle core piece 31 along the first direction D1 includes a length Lg of the gap material 3g along the first direction D1. The same applies also to lengths of the other core pieces and core parts.

The length of the middle core piece 31 along the first direction D1 is, in this example, equal to a length of the first side core piece 321 along the first direction D1 and that of the second side core piece 322 along the first direction D1. The length of the first side core piece 321 along the first direction D1 and that of the second side core piece 322 along the first direction D1 are described later.

(First Side Core Piece, Second Side Core Piece)

As shown in FIGS. 1 and 2, the first and second side core pieces 321, 322 are arranged to face each other across the middle core piece 31. The first and second side core pieces 321, 322 are arranged on the outer periphery of the winding portion 21. The first and second side core pieces 321, 322 have the same shape and are in the form of thin rectangular columns.

The first side core piece 321 is, for example, composed of one core part as in this example shown in FIGS. 1 and 2, the third embodiment shown in FIG. 9 and the like. Further, the first side core piece 321 may be composed of two core parts including a first side core part 321f and a first side core part 321s as in the second and fourth embodiments shown in FIGS. 8 and 10. Similarly, the second side core piece 322 is, for example, composed of one core part as in this example, the third embodiment and the like. Further, the second side core piece 322 may be composed of two core parts including a second side core part 322f and a second side core part 322s as in the second and fourth embodiments.

A length L21 of the first side core piece 321 along the first direction D1 and a length L22 of the second side core piece 322 along the first direction D1 are equal to each other and longer than the length of the winding portion 21 along the axial direction as shown in FIG. 2. Unlike this example, the lengths L21, L22 may be equal to the length of the winding portion 21 along the axial direction. A length of the first side core piece 321 along the second direction D2 and a length of the second side core piece 322 along the second direction D2 are equal to each other. The sum of the length of the first side core piece 321 along the second direction D2 and the length of the second side core piece 322 along the second direction D2 is equivalent to a length of the middle core piece 31 along the second direction D2 in this example. A length of the first side core piece 321 along the third direction D3 and a length of the second side core piece 322 along the third direction D3 are equal to each other and equal to a length of the middle core piece 31 along the third direction D3. That is, in this example, the sum of a cross-sectional area of the first side core piece 321 and that of the second side core piece 322 is equal to a cross-sectional area of the middle core piece 31. The length of the first side core piece 321 along the third direction D3 and the length of the second side core piece 322 along the third direction D3 are shorter than the length of the winding portion 21 along the third direction D3. The length of the first side core piece 321 along the third direction D3 and the length of the second side core piece 322 along the third direction D3 may be longer than the length of the middle core piece 31 along the third direction D3. The length of the first side core piece 321 along the third direction D3 and the length of the second side core piece 322 along the third direction D3 may be equal to the length of the winding portion 21 along the third direction D3. The length of the first side core piece 321 along the third direction D3 and the length of the second side core piece 322 along the third direction D3 may be longer than the length of the winding portion 21 along the third direction D3.

(First End Core Piece, Second End Core Piece)

The first end core piece 33f is facing one end surface of the winding portion 21. The second end core piece 33s is facing the other end surface of the winding portion 21. Facing means that the core piece and the end surface of the winding portion 21 are facing each other. The first and second end core pieces 33f, 33s are in the form of thin rectangular columns as shown in FIGS. 1 and 2.

A length of the first end core piece 33f along the first direction D1 and that of the second end core piece 33s along the first direction D1 may be equal. The length of the second end core piece 33s along the first direction D1 may be shorter than that of the first end core piece 33f along the first direction D1. As shown in FIG. 2, a length of the first end core piece 33f along the second direction D2 and that of the second end core piece 33s along the second direction D2 are equal to each other and longer than the length of the winding portion 21 along the second direction D2. A length of the first end core piece 33f along the third direction D3 and that of the second end core piece 33s along the third direction D3 are equal to each other and shorter than the length of the winding portion 21 along the third direction D3 as shown in FIG. 1. The length of the first end core piece 33f along the third direction D3 and that of the second end core piece 33s along the third direction D3 may be longer than the length of the winding portion 21 along the third direction D3. The length of the first end core piece 33f along the third direction D3 and that of the second end core piece 33s along the third direction D3 may be equal to the length of the winding portion 21 along the third direction D3.

(Combination)

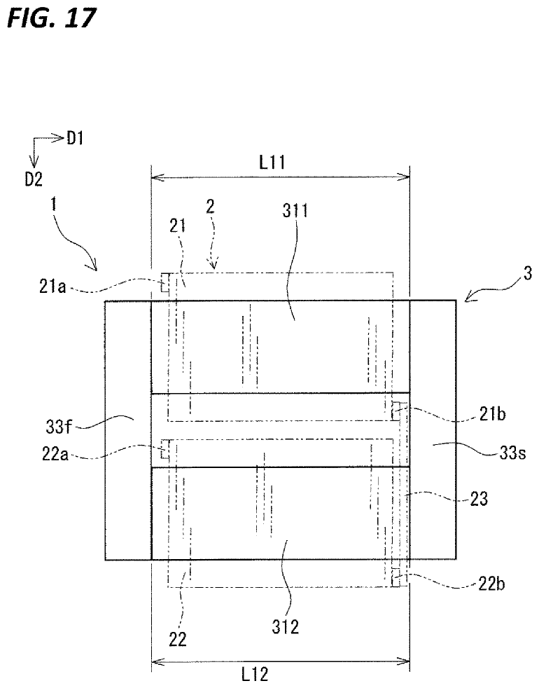

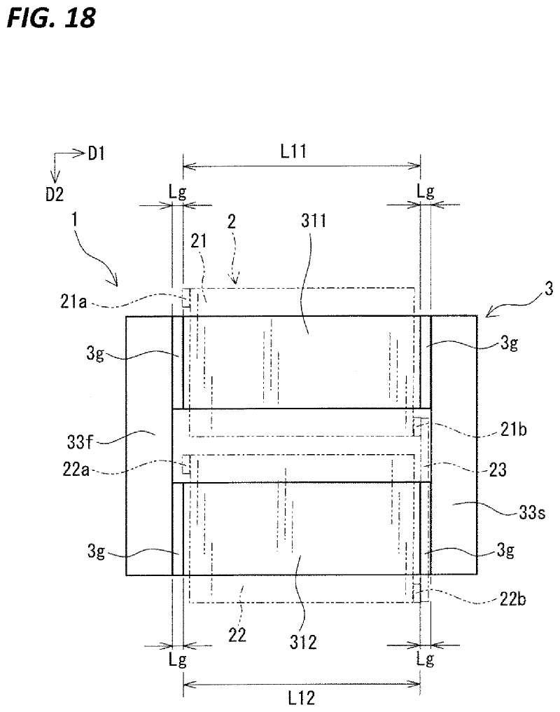

The magnetic core 3 is configured by combining two or more core pieces. FIGS. 1 and 2 referred to in this example, FIGS. 8 to 11 referred to in the second to fifth embodiments and FIGS. 14 to 16 referred to in the sixth to eighth embodiments show an example in which the magnetic core 3 is provided with two core pieces including a first core piece 3f and a second core piece 3s. FIGS. 17 and 18 referred to in the ninth and tenth embodiments show an example in which the magnetic core 3 is provided with three or more core pieces.

The magnetic core 3 of this example is a set obtained by combining the two core pieces, i.e. the first and second core pieces 3f, 3s to be described in detail later, in the axial direction of the winding portion 21. By combining the first and second core pieces 3f, 3s, various combinations can be provided by appropriately selecting the shape of the first core piece 3f and that of the second core piece 3s. The shape of the first core piece 3f and that of the second core piece 3s may be symmetrical, but are preferably asymmetrical. Symmetry means that the shapes and sizes are the same. Asymmetry means that the shapes are different. By being asymmetrical, options for the shape of the first core piece 3f and that of the second core piece 3s are expanded. In this example, the shape of the first core piece 3f and that of the second core piece 3s are asymmetrical.

A combination of the first and second core pieces 3f, 3s is of an E-T type in this example. The above combination may be of an E-E type as in the second embodiment, an E-I type as in the third embodiment or an E-U type as in the fourth embodiment. These combinations enable easier adjustment of the inductance and heat dissipation of the reactor 1. Further, the reactor 1 is excellent in manufacturing workability since the reactor 1 can be constructed by combining the first and second core pieces 3f, 3s with the winding portion 21 along the axial direction of the winding portion 21.

(First Surface, Second Surface)

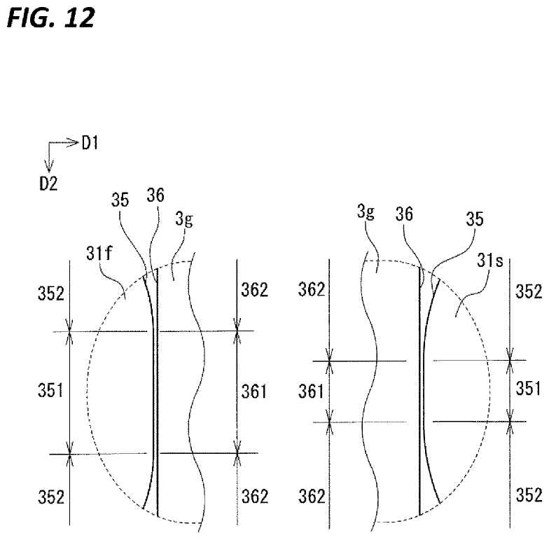

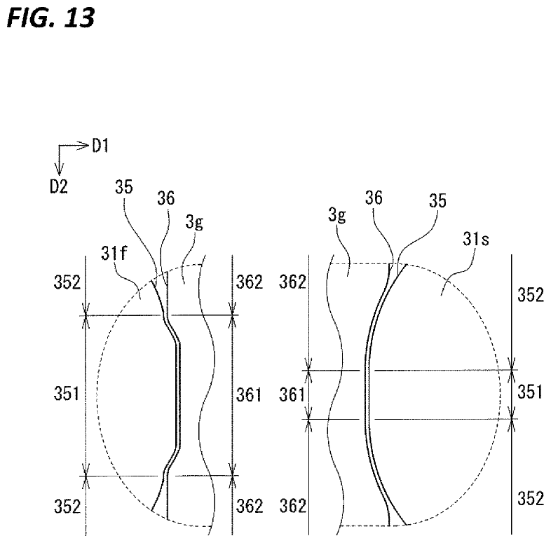

The magnetic core 3 has the first surface 35 and the second surface 36. The first and second surfaces 35, 36 are facing each other. The first surface 35 is made of a material mainly containing a magnetic material. The second surface 36 may be made of a material mainly containing a magnetic material or may be made of a material mainly containing a non-magnetic material. FIGS. 3 and 4 referred to in this example show an example in which the first and second surfaces 35, 36 are made of a material mainly containing a magnetic material. FIGS. 12 and 13 referred to in the fifth embodiment show an example in which the first surface 35 is made of a material mainly containing a magnetic material and the second surface 36 is made of a material mainly containing a non-magnetic material. The first and second surfaces 35, 36 are shown in an exaggerated manner for the convenience of description in FIGS. 3, 4, 12 and 13. That the first and second surfaces 35, 36 are made of a material mainly containing a magnetic material means that a member having the first surface 35 and a member having the second surface 36 are made of the material mainly containing the magnetic material. That the second surface 36 is made of a material mainly containing a non-magnetic material means that the member having the second surface 36 is made of the material mainly containing the non-magnetic material. The material mainly containing the magnetic material means a material containing 20% by volume or more of the magnetic material. The material mainly containing the non-magnetic material means a material containing more than 80% by volume of the non-magnetic material.

The first surface 35 is provided on the core piece. The core piece having the first surface 35 is made of the material mainly containing the magnetic material. The second surface 36 may be provided on the core piece as in this example shown in FIGS. 3 and 4 or may be provided on the gap material 3g as in the later-described fifth embodiment shown in FIGS. 12 and 13. If the second surface 36 is provided on the core piece, the core piece having the second surface 36 is made of the material mainly containing the magnetic material. If the second surface 36 is provided on the gap material 3g, the gap material 3g having the second surface 36 is made of the material mainly containing the non-magnetic material. Specific constituent materials of the core pieces and the gap material 3g are described later.

The first surface 35 has a first region 351. The second surface 36 has a second region 361. The first region 351 has a surface property following that of the second surface 36. Similarly, the second region 361 has a surface property following that of the first surface 35.

That the first region 351 has the surface property following that of the second surface 36 means to satisfy at least one of having a surface property simulating that of the second surface 36, having a surface property in accordance with that of the second surface 36, having a surface property corresponding to that of the second surface 36 and having a surface property copied from that of the second surface 36. Similarly, that the second region 361 has the surface property following that of the first surface 35 means to satisfy at least one of having a surface property simulating that of the first surface 35, having a surface property in accordance with that of the first surface 35, having a surface property corresponding to that of the first surface 35 and having a surface property copied from that of the first surface 35. When the first and second regions 351, 361 are microscopically viewed, recesses in the surface of the first region 351 and projections on the surface of the second region 361 are fit and a projection on the surface of the first region 351 and a recess in the surface of the second region 361 are fit. The first and second regions 351, 361 may be held in close contact without providing any gap between the projections and recesses of the surfaces or a tiny gap may be provided between the projections and recesses of the surfaces. Although an interval is provided between the first and second regions 351, 361 for the convenience of description in FIGS. 3 and 4, the first and second regions 351, 361 are actually in close contact with each other. The first and second regions 351, 361 may have the same surface roughness.

The first and second regions 351, 361 are formed by the mutually facing surfaces of the first and second core pieces 3f, 3s pushing each other in the manufacturing process of the reactor 1 to be described in detail later. That is, the first region 351 provided on the first core piece 3f is formed by transferring the surface property of the second core piece 3s. Further, in the manufacturing process of the reactor 1, the second region 361 provided on the second core piece 3s is formed by transferring the surface property of the first core piece 3f.

The first and second regions 351, 361 contribute to the positioning of the first and second surfaces 35, 36. Thus, the first and second regions 351, 361 contribute to the positioning of the first and second core pieces 3f, 3s. Moreover, the first and second regions 351, 361 contribute to absorbing dimensional tolerances of the first and second core pieces 3f, 3s. Thus, it can be suppressed that an unnecessary interval is provided between the first and second core pieces 3f, 3s.

The first surface 35 may further have at least either non-contact regions 352 shown in FIG. 3 or contact regions 353 shown in FIG. 4. The second surface 36 may further have at least either non-contact regions 362 shown in FIG. 3 or contact regions 363 shown in FIG. 4.

The non-contact region 352 is a region apart from the first and second surfaces 35, 36 without contacting the second surface 36. Similarly, the non-contact region 362 is a region apart from the first and second surfaces 36, 36 without contacting the first surface 35. Since gaps can be provided between the first and second surfaces 35, 36 by the non-contact regions 352 and 362, the reactor 1 easily adjust an inductance.

If the first surface 35 has the non-contact regions 352 and the second surface 36 has the non-contact regions 362 as shown in FIG. 3, intervals are provided between the non-contact regions 352 of the first surface 35 and the non-contact regions 362 of the second surface 36. The above intervals function as gaps of the magnetic core 3. The gap material 3g may be disposed in the above intervals or air gaps may be provided without disposing the gap material 3g. The gap material 3g disposed in the above intervals is, for example, formed by filling a constituent material of the molded resin portion 4 to be described later. If the first surface 35 has the contact regions 353 as shown in FIG. 4, the second surface 36 also have the contact regions 363. No intervals are provided between the contact regions 353 and 363.

The contact region 353 is a region in contact with the second surface 36 without having a surface property following that of the second surface 36. Similarly, the contact region 363 is a region in contact with the second surface 36 without having a surface property following that of the first surface 35. When these contact regions 353, 363 are microscopically viewed, the contact regions 353, 363 are not in close contact, irregularities thereof do not correspond, and there are many positions where projections are facing each other and recesses are facing each other. Intervals are present between the projections and between the recesses. Although intervals are shown between the contact regions 353 and 363 for the convenience of description in FIG. 4, the contact regions 353, 363 are actually in contact with each other. By the contact regions 353, 363, a contact area of the first and second surfaces 35, 36 is increased as compared to the case where the first and second surfaces 35, 36 do not have the contact regions 353, 363. Thus, thermal conductivity between the first and second surfaces 35, 36 is easily increased and, eventually, the thermal conductivity of the magnetic core 3 is easily increased.

One, two or more pairs of the first and second surfaces 35, 36 may be provided. In this example, one pair of the first and second surfaces 35, 36 are provided.

The first surface 35 of this example is provided on the first middle core part 31f of the first core piece 3f to be described in detail later. The second surface 36 of this example is provided on the second middle core part 31s of the second core piece 3s to be described in detail later.

(Third Surface, Fourth Surface)

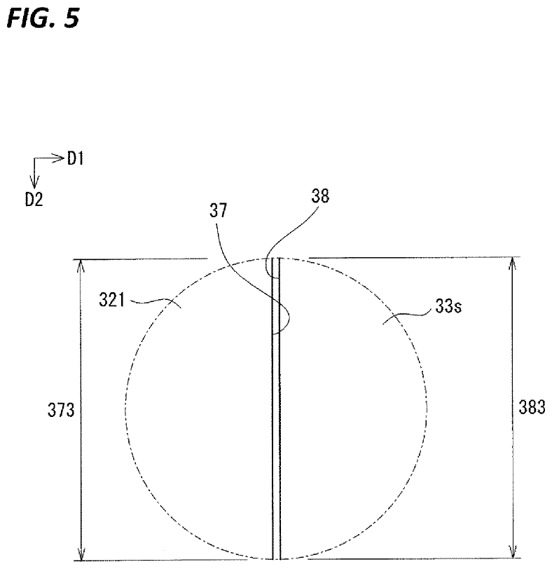

As shown in FIG. 5, the magnetic core 3 may further have a third surface 37 and a fourth surface 38. The third and fourth surfaces 37, 38 are facing each other. Unlike the first and second surfaces 35, 36, the third and fourth surfaces 37, 38 do not have surface properties following those of the others. The third and fourth surfaces 37, 38 have at least one of a contact region 373, 383 and a non-contact region. The contact regions 373, 383 are regions in contact with each other without having surface properties following those of the others. The non-contact regions are regions provided apart from each other. Although an interval is shown between the contact regions 373 and 383 for the convenience of description in FIG. 5, the contact regions 373, 383 are actually in contact with each other. By the contact regions 373, 383, a contact area of the first and second surfaces 37, 38 is increased. Thus, thermal conductivity between the third and fourth surfaces 37, 38 is easily increased and, eventually, the thermal conductivity of the magnetic core 3 is easily increased.

The magnetic core 3 of this example has the third and fourth surfaces 37, 38. One, two or more pairs of the first and second surfaces 37, 38 may be provided. In this example, two pairs of the first and second surfaces 37, 38 are provided.

The third surfaces 37 of this example are provided on the first and second side core pieces 321, 322 of the first core piece 3f to be described in detail later. The fourth surfaces 38 of this example are provided on the first and second end core piece 33s of the second core piece 3s to be described in detail later.

(First Core Piece, Second Core Piece)

The first core piece 3f is E-shaped in this example. The first core piece 3f is an integrated compact of the first end core piece 33f, the first middle core part 31f, the first side core piece 321 and the second side core piece 322. The first end core piece 33f links the first middle core part 31f, the first side core piece 321 and the second side core piece 322. The first and second side core pieces 321, 322 are provided on both ends of the first end core piece 33f. The first middle core part 31f is provided in a center of the first end core piece 33f.

The second core piece 3s is T-shaped in this example. The second core piece 3s is an integrated compact of the second end core piece 33s and the second middle core part 31s. The second middle core part 31s is provided in a center of the second end core piece 33s.

In this example, as shown in FIG. 2, the length Lis of the second middle core part 31s along the first direction D1 is shorter than the length L1f of the first middle core part 31f along the first direction D1. Unlike this example, the lengths L1f, Lis may be equal.

The end surface of the first middle core part 31f and that of the second middle core part 31s are facing each other. The inner end surface of the second end core piece 33s has regions respectively facing the end surface of the first side core piece 321 and that of the second side core piece 322.

In this example, as shown in FIGS. 3 and 4, the end surface of the first middle core part 31f is constituted by the first surface 35, and the end surface of the second middle core part 31s is constituted by the second surface 36. As shown in FIG. 5, the end surface of the first side core piece 321 is constituted by the third surface 37. As shown in FIG. 5, a part of the inner end surface of the second end core piece 33s facing the end surface of the first side core piece 321 has the fourth surface 38 without having a second surface. Further, the end surface of the second side core piece 322 is constituted by a third surface similar to the third surface 37 of the first side core piece 321 shown in FIG. 5. A part of the inner end surface of the second end core piece 33s facing the end surface of the second side core piece 322 is constituted by a fourth surface similar to the fourth surface 38 of the second end core piece 33s shown in FIG. 5 without having a second surface.

Unlike this example, each end surface may be as follows. The end surface of the first middle core part 31f, that of the first side core piece 321 and that of the second side core piece 322 are constituted by the first surfaces 35. The end surface of the second middle core part 31s is constituted by the second surface 36 and the inner end surface of the second end core piece 33s has two second surfaces 36. Alternatively, each end surface may be as follows. The end surface of the first side core piece 321 and that of the second side core piece 322 are constituted by the first surfaces 35. The inner end surface of the second end core piece 33s has two second surfaces 36. The end surface of the first middle core part 31f is constituted by the third surface 37. The end surface of the second middle core part 31s is constituted by the fourth surface 38.

As shown in FIG. 3, the first surface 35 of this example has the first region 351 and the non-contact regions 352. The first region 351 of this example is provided substantially over an entire length in the third direction D3 in a center in the second direction D2 of the first surface 35. The first region 351 of this example is convex. The tip of this first region 351 is, for example, formed into a flat surface. The non-contact regions 352 of the first surface 35 of this example are provided substantially over an entire length in the third direction D3 on both sides in the second direction D2 of the first region 351 on the first surface 35. The non-contact regions 352 of the first surface 35 of this example, are, for example, formed into arcuate surfaces.

As shown in FIG. 3, the second surface 36 of this example has the second region 361 and the non-contact regions 362. The second region 361 of this example is in close contact with the first region 351. The second region 361 of this example is provided substantially over an entire length in the third direction D3 in a center in the second direction D2 of the second surface 36. The second region 361 of this example is concave. The bottom surface of this second region 361 is, for example, formed into a flat surface. The non-contact regions 362 of the second surface 36 of this example are provided substantially over an entire length in the third direction D3 on both sides in the second direction D2 of the second region 361 on the second surface 36. The non-contact regions 362 of the second surface 36 of this example are, for example, formed into flat surfaces.

Alternatively, as shown in FIG. 4, the first surface 35 of this example has the first region 351 and the contact regions 353. The first region 351 of FIG. 4 is similar to the first region 351 of FIG. 3 described above. The contact regions 353 are, for example, formed into flat surfaces. The second surface 36 of this example has the second region 361 and the contact regions 363 as shown in FIG. 4. The second region 361 of FIG. 4 is similar to the second region 361 of FIG. 3 described above. The contact regions 363 are, for example, formed into flat surfaces.

Note that the first surface 35 may have the first region 351, the non-contact region 352 (FIG. 3) and the contact region 353 (FIG. 4), and the second surface 36 may have the second region 361, the non-contact region 362 (FIG. 3) and the contact region 363 (FIG. 4).

As shown in FIG. 5, in this example, the third surface 37 is substantially constituted by the contact region 373, and the fourth surface 38 is substantially constituted by the contact region 383. The contact region 373 is provided substantially over the entire region of the third surface 37, and the contact region 383 is provided substantially over the entire region of the fourth surface 38. The third surface 37 is constituted by a flat surface. The fourth surface 38 is constituted by a flat surface.

(Materials)

The first and second core pieces 3f, 3s are constituted by compacts. The compact is either a powder compact or a compact of a composite material. The compacts constituting the first and second core pieces 3f, 3s are made of mutually different materials. The mutually different materials mean not only a case where materials of individual constituent elements of each core piece are different, but also a case where contents of a plurality of constituent elements are different even if the materials of the individual constituent elements are the same. For example, even if the first and second core pieces 3f, 3s are constituted by powder compacts, these core pieces 3f, 3s are regarded as made of mutually different materials if the materials and contents of soft magnetic powders constituting the powder compacts are different. Further, even if the first and second core pieces 3f, 3s are constituted by compacts of composite materials, these core pieces 3f, 3s are regarded as made of mutually different materials if at least one of materials including a soft magnetic powder and a resin constituting the composite material is different or if the contents of the soft magnetic powder and the resin are different even if the materials of the soft magnetic powders and resins are the same.

The powder compact is obtained by compression-forming a soft magnetic powder. The powder compact has a higher ratio of the soft magnetic powder occupying the core piece as compared to composite materials. Thus, the powder compact easily enhances magnetic properties. A saturated magnetic flux density and a relative magnetic permeability can be cited as the magnetic properties. Further, by containing less resin and more soft magnetic powder than the compact of the compositive material, the powder compact is excellent in heat dissipation. A content of the magnetic powder in the powder compact is, for example, 85% by volume or more and 99.99% by volume or less if the powder compact is 100% by volume.

In the composite material, the soft magnetic powder is dispersed in the resin. The composite material is obtained by filling a fluid raw material, in which the soft magnetic powder is dispersed in the uncured resin, into a mold and solidifying the resin. The composite material can easily adjust a content of the soft magnetic powder in the resin. Thus, the composite material easily adjusts magnetic properties. Moreover, the composite material is easily formed into even a complicated shape as compared to the powder compact. A content of the soft magnetic powder in the compact of the composite material is, for example, 20% by volume or more and 80% by volume or less if the composite material is 100% by volume. A content of the resin in the compact of the composite material is, for example, 20% by volume or more and 80% by volume or less if the composite material is 100% by volume.

Particles of soft magnetic metals, coated particles including insulation coatings on the outer peripheries of particles of soft magnetic metals, particles of soft magnetic nonmetals and the like can be cited as particles constituting the soft magnetic powder. Pure iron and iron-based alloys can be cited as the soft magnetic metal. Fe—Si alloys, Fe—Ni alloys and the like can be cited as the iron-based alloys. Phosphates and the like can be cited as materials of the insulation coatings. Ferrite and the like can be cited as the soft magnetic nonmetals.

Thermosetting resins and thermoplastic resins can be, for example, cited as the resin of the composite material. An epoxy resin, a phenol resin, a silicone resin, a urethane resin and the like can be, for example, cited as the thermosetting resins. A polyphenylene sulfide resin, a polyamide resin, a liquid crystal polymer, a polyimide resin, a fluororesin and the like can be, for example, cited as the thermoplastic resins. Nylon 6, nylon 66, nylon 9T and the like can be, for example, cited as the polyimide resin.

These resins may contain ceramic fillers. Alumina, silica and the like can be, for example, cited as the ceramic fillers. Resins containing these ceramic fillers are excellent in heat dissipation and electrical insulation.

The content of the soft magnetic powder in the powder compact or the compact of the composite material is regarded as equivalent to an area ratio of the soft magnetic powder in a cross-section of the compact. The content of the soft magnetic powder in the compact is obtained as follows. An observation image is obtained by observing the cross-section of the compact by a SEM (Scanning Electron Microscope). A magnification of the SEM is 200× or more and 500× or less. 10 or more observation images are obtained. A total cross-sectional area is 0.1 cm² or more. One observation image may be obtained for one cross-section or a plurality of observation images may be obtained for one cross-section. An image processing is applied to each obtained observation image and the contours of the particles are extracted. A binarization processing can be, for example, cited as the image processing. An area ratio of the soft magnetic particles is calculated in each observation image and an average value of the area ratios is obtained. That average value is regarded as the content of the soft magnetic powder.

In this example, the first core piece 3f is constituted by a compact of a composite material, and the second core piece 3s is constituted by a powder compact. By constituting the first core piece 3f by the compact of the composite material and constituting the second core piece 3s by the powder compact, the inductance is easily adjusted and, moreover, heat dissipation is easily adjusted as compared to the case where the magnetic core 3 is made of a single material.

(Relative Magnetic Permeability, Saturated Magnetic Flux Density, Iron Loss, Thermal Conductivity)

The magnetic core 3 preferably satisfies a relationship of “the relative magnetic permeability of the first core piece 3f<the relative magnetic permeability of the second core piece 3s”. By satisfying this relative magnetic permeability magnitude relationship, the inductance is easily adjusted. Further, a leakage magnetic flux through between the first and second core pieces 3f, 3s is easily suppressed. Thus, the leakage magnetic flux intrudes into the coil 2 and easily reduces an eddy current loss generated in the coil 2. Moreover, problems such as the influence of the leakage magnetic flux on peripheral devices of the reactor 1 are easily suppressed. After the above relative magnetic permeability magnitude relationship is satisfied, the relative magnetic permeability of the first core piece 3f is preferably 50 or less and that of the second core piece 3s is preferably 50 or more. The reason for that is that the inductance is easily adjusted. The relative magnetic permeability of the first core piece 3f is more preferably 45 or less and particularly preferably 40 or less. The relative magnetic permeability of the first core piece 3f is, for example, 5 or more. The relative magnetic permeability of the second core piece 3s is preferably 100 or more and particularly preferably 150 or more. The relative magnetic permeability of the second core piece 3s is, for example, 500 or less. The first and second core pieces 3f, 3s preferably satisfy a relationship of “the saturated magnetic flux density of the first core piece 3f<the saturated magnetic flux density of the second core piece 3s.”

The magnetic core 3 preferably satisfies relationships of “the iron loss of the first core piece 3f<the iron loss of the second core piece 3s” and “the thermal conductivity of the first core piece 3f<the thermal conductivity of the second core piece 3s.” By satisfying these iron loss magnitude relationship and thermal conductivity magnitude relationship, the temperature of the reactor 1 is less likely to rise. The reason for that is that the second core piece 3s has a large iron loss and easily generates heat, but has a large thermal conductivity and is high in heat dissipation, and the first core piece 3f has a small thermal conductivity and is low in heat dissipation, but has a small iron loss and is less likely to generate heat. The thermal conductivity of the first core piece 3f is, for example, preferably 1 W/m·K or more, more preferably 2 W/m·K and particularly preferably 3 W/m·K. The thermal conductivity of the first core piece 3f is, for example, practically 5 W/m·K or less. The thermal conductivity of the second core piece 3s is, for example, preferably 5 W/m·K or more, more preferably 10 W/m·K and particularly preferably 15 W/m·K. The thermal conductivity of the first core piece 3f is, for example, practically 20 W/m·K or less.

The relative magnetic permeability is obtained as follows. Ring-shaped measurement samples are cut out respectively from the first and second core pieces 3f, 3s. Primary winding: 300 turns and secondary winding: 20 turns are applied to each of the measurement samples. A B-H initial magnetization curve is measured in a range of H=0 (Oe) or more and 100 (Oe) or less, and a maximum value of a gradient of this B-H initial magnetization curve is obtained, and this maximum value is set as a relative magnetic permeability. Note that the magnetization curve here is a so-called direct-current magnetization curve. The saturated magnetic flux density is obtained as follows using the above respective measurement samples. A magnetic field of 795.8 kA/m is applied to each of the measurement samples by an electromagnet and a magnetic flux density when the measurement sample is sufficiently magnetically saturated is set as the saturated magnetic flux density. The iron loss is obtained as follows using the above respective measurement samples. Using a BH curve tracer, an iron loss (W/m³) at an excitation magnetic flux density Bm: 1 kG (=0.1T) and a measurement frequency: 10 kHz is measured. The thermal conductivity is obtained by a measurement applying a temperature gradient method or laser flash method to each of the first and second core pieces 3f, 3s.

[Molded Resin Portion]

The reactor 1 preferably includes the molded resin portion 4 as shown in FIG. 1. The molded resin portion 4 is not shown for the convenience of description in FIG. 2. The molded resin portion 4 at least partially covers the magnetic core 3. This molded resin portion 4 easily protects the magnetic core 3 from an external environment. The molded resin portion 4 may cover the outer periphery of the magnetic core 3 without covering the outer periphery of the coil 2 or may cover both the outer periphery of the magnetic core 3 and that of the coil 2. If the molded resin portion 4 is interposed between the coil 2 and the magnetic core 3, insulation between the coil 2 and the magnetic core 3 is easily ensured. If the molded resin portion 4 is present between the plurality of core pieces or between the coil 2 and the magnetic core 3, the core pieces or the coil 2 and the magnetic core 3 are easily positioned or fixed with respect to each other.

The molded resin portion 4 of this example covers the outer periphery of an assembly of the coil 2 and the magnetic core 3. The assembly is protected from an external environment by the molded resin portion 4. Moreover, the coil 2 and the magnetic core 3 are integrated by the molded resin portion 4.

The molded resin portion 4 of this example is interposed between the coil 2 and the magnetic core 3 shown in FIG. 1 and between the non-contact regions 352 of the first surface 35 of the first middle core part 31f and the non-contact regions 362 of the second surface 36 of the second middle core part 31s shown in FIG. 3. The molded resin portion 4 interposed between the non-contact regions 352 of the first surface 35 and the non-contact regions 362 of the second surface 36 constitutes the gap material 3g. The molded resin portion 4 is not interposed between the contact regions 353 of the first surface 35 of the first middle core part 31f and the contact regions 363 of the second surface 36 of the second middle core part 31s shown in FIG. 4. The molded resin portion 4 is not interposed between the third surfaces 37 of the first core piece 3f and the fourth surfaces 38 of the second core piece 3s shown in FIG. 5. If each of the third surfaces 37 and the fourth surfaces 38 has non-contact regions unlike this example, the molded resin portion 4 may be interposed also between the non-contact regions of the third surfaces 37 and the non-contact regions of the fourth surfaces 38. The molded resin portion 4 interposed between the non-contact regions of the third surfaces 37 and the non-contact regions of the fourth surfaces 38 also constitutes the gap material.

The resin of the molded resin portion 4 is, for example, a resin similar to the resin of the composite material described above. The resin of the molded resin portion 4 may contain a ceramic filler similarly to the composite material.

[Miscellaneous]

Although not shown, the reactor 1 may include at least one of a case, an adhesive layer and a holding member. The case accommodates the assembly of the coil 2 and the magnetic core 3 inside. The assembly in the case may be embedded by a sealing resin portion. The adhesive layer fixes the assembly to a placing surface, fixes the assembly to the inner bottom surface of the case and fixes the case to the placing surface or the like. The holding member is interposed between the coil 2 and the magnetic core 3 to ensure insulation between the coil 2 and the magnetic core 3.

[Manufacturing Method]

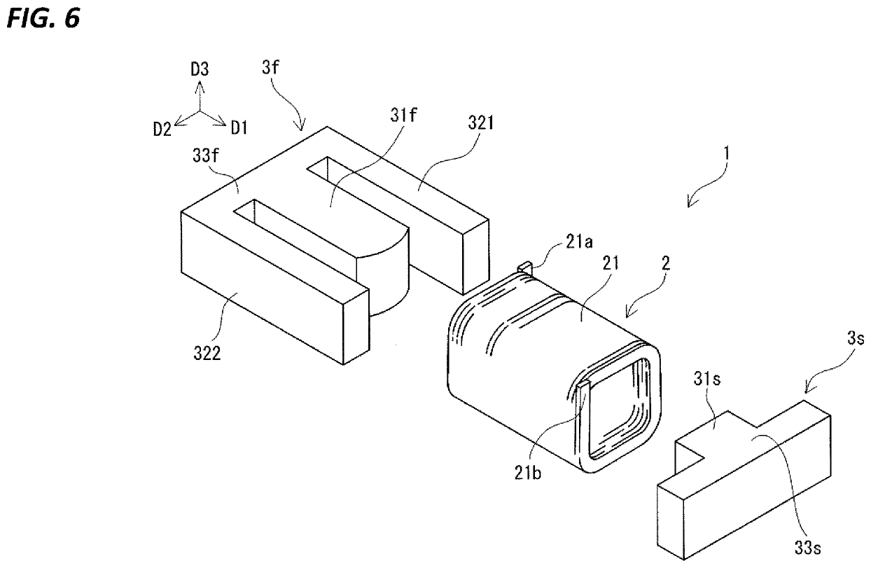

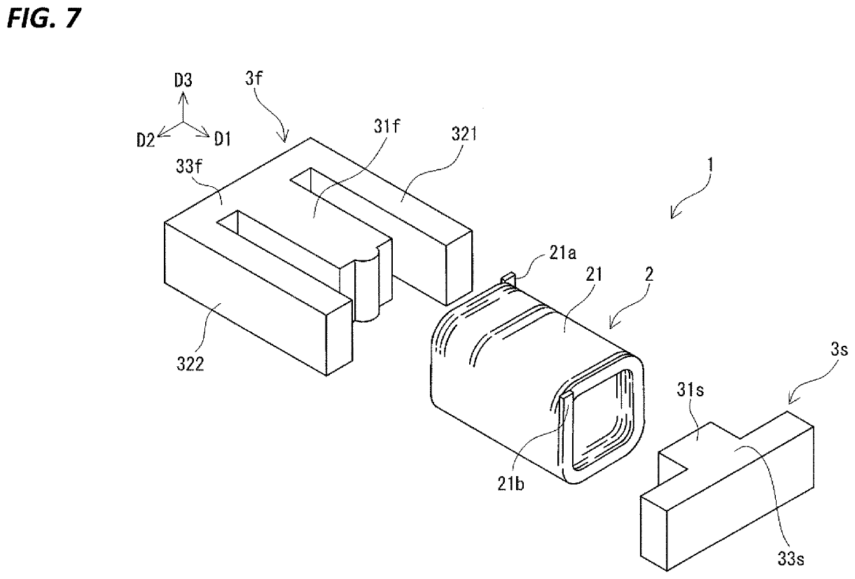

A reactor manufacturing method for manufacturing the reactor 1 is described with reference to FIGS. 6 and 7. The reactor manufacturing method includes a step of fabricating the set by combining the magnetic core 3 with the coil 2. This step of fabricating the set includes the following process A and process B.

In the process A, a part of the magnetic core 3 is inserted into the coil 2 and parts of the first core piece 3f and parts of the second core piece 3s are brought into contact. FIGS. 6 and 7 show a state before the parts of the first core piece 3f and the parts of the second core piece 3s are brought into contact.

In the process B, the first and second core pieces 3f, 3s are pressed in directions toward each other with the parts of the first core piece 3f and the parts of the second core piece 3s held in contact.

(Process A)

The first and second middle core parts 31f, 31s are inserted into the inside of the winding portion 21. A part of at least one end surface, out of the end surface of the first middle core part 31f, that of the first side core piece 321 and that of the second side core piece 322, and a part of at least one end surface, out of the end surface of the second middle core part 31s and the inner end surface of the second end core piece 33s, are brought into contact. In this example, a part of the end surface of the first middle core part 31f of the first core piece 3f and a part of the end surface of the second middle core part 31s of the second core piece 3s are brought into contact inside the winding portion 21.

<First Core Piece>

In the first core piece 3f before contact, the end surface of the first middle core part 31f has a convex surface projecting toward the second middle core part 31s. Further, the end surface of the first side core piece 321 and that of the second side core piece 322 are constituted by flat surfaces.

One convex surface may be provided as in this example, or a plurality of convex surfaces may be provided unlike this example. One convex surface may be provided over the entire region of the end surface of the first middle core part 31f as shown in FIG. 6 or may be provided in a part of the end surface of the first middle core part 31f as shown in FIG. 7. The convex surface is shown in an exaggerated manner for the convenience of description in FIGS. 6 and 7. In FIG. 6, the entire region of the end surface of the first middle core part 31f is constituted by the convex surface. If the convex surface is provided only in a part of the end surface, the end surface of the first middle core part 31f is, for example, constituted by one convex surface and at least one flat surface. In FIG. 7, the end surface of the first middle core part 31f is constituted by one convex surface provided in a center in the second direction D2 and a total of two flat surfaces provided on both sides of the convex surface in the second direction D2.

The convex surface may have an arcuate shape as shown in FIGS. 6 and 7 or may have a spherical shape unlike this example. The arcuate convex surface may be so formed that a chord of an arc extends along the end surface of the first middle core part 31f in the second direction D2 as in this example. The arcuate convex surface may be formed such that the chord of the arc extends along the end surface of the first middle core part 31f in the third direction D3 unlike this example.

The convex surface may be formed as the first core piece 3f is fabricated or may be formed by separately applying machining to the fabricated first core piece 3f.

<Second Core Piece>

The end surface of the second middle core part 31s of this example is constituted by a flat surface. Unlike this example, the end surface of the second middle core part 31s may have a convex surface projecting toward the first middle core part 31f similarly to the end surface of the first middle core part 31f. The inner end surface of the second end core piece 33s is constituted by a flat surface.

Lengths of the first middle core part 31f, the second middle core part 31s, the first side core piece 321 and the second side core piece 322 along the first direction D1 are appropriately adjusted to satisfy the following requirements (a) and (b) after the process B to be described later.
(a) The end surface of the first side core piece 321 and the inner end surface of the second end core piece 33s are in contact.
(b) The end surface of the second side core piece 322 and the inner end surface of the second end core piece 33s are in contact.

By this length adjustment, the reactor 1 can be manufactured after the process B to be described later. That is, the first surface 35 is provided on the end surface of the first middle core part 31f. The second surface 36 is provided on the end surface of the second middle core part 31s. The third surfaces 37 are provided on the end surfaces of the first and second side core pieces 321, 322. The two fourth surfaces 38 are provided on the inner end surface of the second end core piece 33s.

For example, the sum of the length of the first middle core part 31f along the first direction D1 and the length of the second middle core part 31s along the first direction D1 is longer than each of the length of the first side core piece 321 along the first direction D1 and the length of the second side core piece 322 along the first direction D1. By satisfying this length relationship, the end surface of the first side core piece 321 and the inner end surface of the second end core piece 33s are not in contact and the end surface of the second side core piece 322 and the inner end surface of the second end core piece 33s are not in contact with a part of the end surface of the first middle core part 31f and a part of the end surface of the second middle core part 31s held in contact. That is, intervals are provided between the end surface of the first side core piece 321 and the inner end surface of the second end core piece 33s and between the end surface of the second side core piece 322 and the inner end surface of the second end core piece 33s.

Unlike this example, the lengths of the first middle core part 31f, the second middle core part 31s, the first side core piece 321 and the second side core piece 322 along the first direction D1 may be appropriately adjusted to satisfy the following requirements (a) and (b) after the process B to be described later.
(a) An interval is provided between the end surface of the first side core piece 321 and the inner end surface of the second end core piece 33s.
(b) An interval is provided between the end surface of the second side core piece 322 and the inner end surface of the second end core piece 33s.

By this length adjustment, the reactor 1 can be manufactured in which gaps are provided between the end surface of the first side core piece 321 and the inner end surface of the second end core piece 33s and between the end surface of the second side core piece 322 and the inner end surface of the second end core piece 33s after the process B to be described later.

(Process B)

How to press the first and second core pieces 31f, 31s is not particularly limited. For example, in the case of including the molded resin portion 4 as in the reactor 1 of this example, the first and second core pieces 3f, 3s may be pressed using a flow of the constituent material of the molded resin portion 4 filled in molding the molded resin portion 4. The coil 2 and the magnetic core 3 are arranged in a mold for molding the molded resin portion 4 with the first and second middle core parts 31f, 31s held in contact in the winding portion 21. The constituent material of the molded resin portion 4 is filled from the outside of the first end core piece 33f and the outside of the second end core piece 33s.

Alternatively, a tightening band may be arranged on the outer periphery of the magnetic core 3 and the first and second core pieces 3f, 3s may be pressed using a tightening force of the tightening band. The molded resin portion 4 may be molded after this pressing.

By this pressing, at least a part of the convex surface on the first middle core part 31f and at least a part of the flat surface on the second middle core part 31s are deformed. By the deformation of the convex surface, the surface property of the flat surface of the second middle core part 31s is transferred to the end surface of the first middle core part 31f, thereby forming the first region 351 having the surface property following that of the flat surface of the second middle core part 31s. By the deformation of the flat surface, the surface property of the convex surface of the first middle core part 31f is transferred to the end surface of the second middle core part 31s, thereby forming the second region 361 having the surface property following that of the convex surface of the first middle core part 31f. At least either the non-contact regions 352 shown in FIG. 3 or the contact regions 353 shown in FIG. 4 are further formed on the end surface of the first middle core part 31f. At least either the non-contact regions 362 shown in FIG. 3 or the contact regions 363 shown in FIG. 4 are further formed on the end surface of the second middle core part 31s. For example, in the case of using the first core piece 3f having the convex surface of FIG. 6, the non-contact regions 352 shown in FIG. 3 are formed on the end surface of the first middle core part 31f and the non-contact regions 362 shown in FIG. 3 are formed on the end surface of the second middle core part 31s. For example, in the case of using the second core piece 3s having the convex surface of FIG. 7, the non-contact regions 353 shown in FIG. 4 are formed on the end surface of the first middle core part 31f and the non-contact regions 363 shown in FIG. 4 are formed on the end surface of the second middle core part 31s.

According to the above deformation, the end surface of the first side core piece 321 and the inner end surface of the second end core piece 33s are brought into contact, and the end surface of the second side core piece 322 and the inner end surface of the second end core piece 33s are brought into contact. Thus, the third surfaces 37 are provided on the end surface of the first side core piece 321 and that of the second side core piece 322, and the two fourth surfaces 38 are provided on the inner end surface of the second end core piece 33s.

[Functions and Effects]

The reactor 1 of this example easily obtains a desired inductance. The reactor 1 of this example is manufactured by the aforementioned reactor manufacturing method. That is, mutual contact parts of the end surfaces of the first and second middle core parts 31f, 31s are deformed by the aforementioned pressing. By this deformation, the end surface of the first middle core part 31f is constituted by the first surface 35 having the first region 351. Further, by this deformation, the end surface of the second middle core part 31s is constituted by the second surface 36 having the second region 361. By this deformation, dimensional tolerances of the first and second side core pieces 321, 322 are absorbed. Thus, the end surface of the first side core piece 321 and the inner end surface of the second end core piece 33s are accurately combined, and the end surface of the second side core piece 322 and the inner end surface of the second end core piece 33s are accurately combined. That is, unnecessary intervals are less likely to be provided between the end surface of the first side core piece 321 and the inner end surface of the second end core piece 33s and between the end surface of the second side core piece 322 and the inner end surface of the second end core piece 33s.

### Second Embodiment

[Reactor]

A reactor 1 according to the second embodiment is described mainly with reference to FIG. 8. The reactor 1 of this example differs from the reactor 1 of the first embodiment in that a combination of first and second core pieces 3f, 3s is of an E-E type. The following description is centered on points of difference from the first embodiment. Components similar to those of the first embodiment may not be described. This way of description applies also to the third to sixth embodiments to be described later. A molded resin portion is not shown for the convenience of description in FIG. 8. The molded resin portion is not shown also in FIGS. 9 to 11 respectively referred to in the third to fifth embodiments and FIGS. 14 to 18 respectively referred to in the sixth to tenth embodiments to be described later.

[Magnetic Core]

(First Core Piece, Second Core Piece)

The first core piece 3f is E-shaped. The first core piece 3f is an integrated compact of a first end core piece 33f, a first middle core part 31f, a first side core part 321f and a second side core part 322f. The first end core piece 33f links the first middle core part 31f, the first side core part 321f and the second side core part 322f. The first and second side core parts 321f, 322f are provided on both ends of the first end core piece 33f. The first middle core part 31f is provided in a center of the first end core piece 33f.

A length L1f of the first middle core part 31f along the first direction D1, a length L21f of the first side core part 321f along the first direction D1 and a length L22f of the second side core part 322f along the first direction D1 are equal. Unlike this example, the lengths L1f, L21f and L22f may not be equal. For example, the length L1f may be longer than the lengths L21f, L22f.

The second core piece 3s is E-shaped. The second core piece 3s is an integrated compact of a second end core piece 33s, a second middle core part 31s, a first side core part 321s and a second side core part 322s. The second end core part 33s links the second middle core part 31s, the first side core part 321s and the second side core part 322s. The first and second side core parts 321s, 322s are provided on both ends of the second end core piece 33s. The second middle core part 31s is provided in a center of the second end core piece 33s.

A length Lis of the second middle core part 31s along the first direction D1, a length L21s of the first side core part 321s along the first direction D1 and a length L22s of the second side core part 322s along the first direction D1 are equal. Unlike this example, the lengths Lis, L21s and L22s may not be equal. For example, the length L1s may be longer than the lengths L21s, L22s.

The length Lis is shorter than the length L1f. The length L21s is shorter than the length L21f. The length L22s is shorter than the length L22f.

Unlike this example, the lengths L1f, L1s may be equal. The lengths L21f, L21s may be equal. The lengths L22f, L22s may be equal.

The end surface of the first middle core part 31f and that of the second middle core part 32f are facing each other. The end surface of the first side core part 321f and that of the first side core part 321s are facing each other. The end surface of the second side core part 322f and that of the second side core part 322s are facing each other.

At least one of the end surface of the first middle core part 31f, that of the first side core part 321f and that of the second side core part 322f is constituted by a first surface 35. At least one of the end surface of the second middle core part 31s, that of the first side core part 321s and that of the second side core part 322s is constituted by a second surface 36.

Each end surface in this example is as follows. The end surface of the first middle core part 31f is constituted by a first surface similar to the first surface 35 shown in FIG. 3 or 4 described in the first embodiment. The end surface of the second middle core part 31s is constituted by a second surface similar to the second surface 36 shown in FIG. 3 or 4. The end surface of the first side core part 321f and that of the second side core part 322f are constituted by third surfaces similar to the third surfaces 37 shown in FIG. 5 described in the first embodiment. The end surface of the first side core part 321s and that of the second side core part 322s are constituted by fourth surfaces similar to the fourth surfaces 38 shown in FIG. 5.

[Functions and Effects]

The reactor 1 of this example easily obtains a desired inductance similarly to the reactor 1 of the first embodiment even if the combination of the first and second core piece 3f, 3s is of the E-E type. This is because dimensional tolerances of first and second side core pieces 321, 322 of the reactor 1 of this example are absorbed in the reactor manufacturing process similarly to the reactor 1 of the first embodiment. Thus, the end surface of the first side core part 321f and that of the first side core part 321s are accurately combined, and the end surface of the second side core part 322f and that of the second side core part 322s are accurately combined. That is, unnecessary intervals are less likely to be provided between the end surface of the first side core part 321f and that of the first side core part 321s and between the end surface of the second side core part 322f and that of the second side core part 322s.

### Third Embodiment

[Reactor]

A reactor 1 according to the third embodiment is described mainly with reference to FIG. 9. The reactor 1 of this example differs from the reactor 1 of the first embodiment in that a combination of first and second core pieces 3f, 3s is of an E-I type.

[Magnetic Core]

(First Core Piece, Second Core Piece)

The first core piece 3f is E-shaped. The first core piece 3f is an integrated compact of a first end core piece 33f, a middle core piece 31, a first side core piece 321 and a second side core piece 322. A length L1 of the middle core piece 31 along the first direction D1, a length L21 of the first side core piece 321 along the first direction D1 and a length L22 of the second side core piece 322 along the first direction D1 are equal. The second core piece 3s is I-shaped. The second core piece 3s is constituted by a second end core piece 33s. The inner end surface of the second end core piece 33s has regions respectively facing the end surface of the middle core piece 31, that of the first side core piece 321 and that of the second side core piece 322.

At least one of the end surface of the middle core piece 31, that of the first side core piece 321 and that of the second side core piece 322 is constituted by a first surface 35. A part of the inner end surface of the second end core piece 33s facing the first surface 35 is constituted by a second surface 36.

Each end surface in this example is as follows. The end surface of the middle core piece 31 is constituted by a first surface similar to the first surface 35 shown in FIG. 3 or 4 described in the first embodiment. The end surface of the first side core piece 321 and that of the second side core piece 322 are constituted by third surfaces similar to the third surfaces 37 shown in FIG. 5 described in the first embodiment. The inner end surface of the second end core piece 33s has one second surface similar to the second surface 36 shown in FIG. 3 or 4 and two fourth surfaces similar to the fourth surfaces 38 shown in FIG. 5.

[Functions and Effects]

The reactor 1 of this example easily obtains a desired inductance similarly to the reactor 1 of the first embodiment even if the combination of the first and second core piece 3f, 3s is of the E-I type. This is because dimensional tolerances of the first and second side core pieces 321, 322 of the reactor 1 of this example are absorbed in the reactor manufacturing process similarly to the reactor 1 of the first embodiment. Thus, the end surface of the first side core piece 321 and the inner end surface of the second end core piece 33s are accurately combined, and the end surface of the second side core piece 322 and the inner end surface of the second end core piece 33s are accurately combined. That is, unnecessary intervals are less likely to be provided between the end surface of the first side core piece 321 and the inner end surface of the second end core piece 33s and between the end surface of the second side core piece 322 and the inner end surface of the second end core piece 33s.

### Fourth Embodiment

[Reactor]

A reactor 1 according to the fourth embodiment is described mainly with reference to FIG. 10. The reactor 1 of this example differs from the reactor 1 of the first embodiment in that a combination of first and second core pieces 3f, 3s is of an E-U type.

[Magnetic Core]

(First Core Piece, Second Core Piece)

The first core piece 3f is E-shaped. The first core piece 3f is an integrated compact of a first end core piece 33f, a middle core piece 31, a first side core part 321f and a second side core part 322f. A length L21f of the first side core part 321f along the first direction D1 and a length L22f of the second side core part 322f along the first direction D1 are equal and shorter than a length L1 of the middle core piece 31 along the first direction D1.

The second core piece 3s is U-shaped. The second core piece 3s is an integrated compact of a second end core piece 33s, a first side core part 321s and a second side core part 322s. A length L21s of the first side core part 321s along the first direction D1 and a length L22s of the second side core part 322s along the first direction D1 are equal.

The length L21s is shorter than the length L21f. The length L22s is shorter than the length L22f.

Unlike this example, the lengths L21f, L21s may be equal. Further, the lengths L22f, L22s may be equal.

The inner end surface of the second end core piece 33s has a region facing the end surface of the middle core piece 31. The end surface of the first side core part 321f and that of the first side core part 321s are facing each other. The end surface of the second side core part 322f and that of the second side core part 322s are facing each other.

At least one of the end surface of the middle core piece 31, that of the first side core part 321f and that of the second side core part 322f is constituted by a first surface 35. A part facing the first surface 35, out of the inner end surface of the second end core piece 33s, the end surface of the first side core part 32s and the end surface of the second side core part 322s, is constituted by a second surface 36.

Each end surface in this example is as follows. The end surface of the middle core piece 31 is constituted by a first surface similar to the first surface 35 shown in FIG. 3 or 4 described in the first embodiment. The inner end surface of the second end core piece 33s has a second surface similar to the second surface 36 shown in FIG. 3 or 4. The end surface of the first side core part 321f and that of the second side core part 322f are constituted by third surfaces similar to the third surfaces 37 shown in FIG. 5 described in the first embodiment. The end surface of the first side core part 321s and that of the second side core part 322s are constituted by fourth surfaces similar to the fourth surfaces 38 shown in FIG. 5.

[Functions and Effects]

The reactor 1 of this example easily obtains a desired inductance similarly to the reactor 1 of the first embodiment even if the combination of the first and second core piece 3f, 3s is of the E-U type. This is because dimensional tolerances of first and second side core pieces 321, 322 of the reactor 1 of this example are absorbed in the reactor manufacturing process similarly to the reactor 1 of the first embodiment. Thus, the end surface of the first side core part 321f and the end surface of the first side core part 321s are accurately combined, and the end surface of the second side core part 322f and the end surface of the second side core part 322s are accurately combined. That is, unnecessary intervals are less likely to be provided between the end surface of the first side core part 321f and that of the first side core part 321s and between the end surface of the second side core part 322f and that of the second side core part 322s.

### Fifth Embodiment

[Reactor]

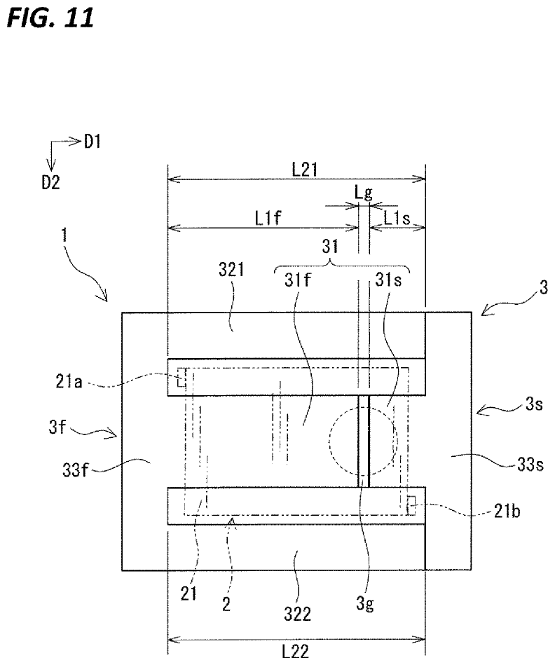

A reactor 1 according to the fifth embodiment is described mainly with reference to FIGS. 11 to 13. The reactor 1 of this example differs from the reactor 1 of the first embodiment in including a gap material 3g interposed between first and second core pieces 3f, 3s. That is, a magnetic core 3 of this example is a set obtained by combining the first and second core pieces 3f, 3s to sandwich the gap material 3g from both sides in an axial direction of a winding portion 21.

[Magnetic Core]

(Gap Material)

The gap material 3g is made of a material mainly containing a non-magnetic material. Mainly containing the non-magnetic material means that a content of the non-magnetic material is more than 80% by volume when the gap material 3g is 100% by volume. A ceramic or resin can be, for example, cited as the non-magnetic material. Alumina, silica and the like can be, for example, cited as the ceramic similarly to the aforementioned ceramic fillers. Thermosetting resins and thermoplastic resins similar to the resin of the aforementioned composite material can be cited as the resin. The aforementioned ceramic filler may be filled in the resin. A content of the ceramic filler contained in the resin is 0.2% by mass or more and 20% by mass or less when the gap material 3g is 100% by mass. A known gap material can be used as the gap material 3g.

The gap material 3g is arranged in at least one of gaps between the end surface of a first middle core part 31f and that of a second middle core part 31s, between the end surface of a first side core piece 321 and the inner end surface of a second end core piece 33s and between the end surface of a second side core piece 322 and the inner end surface of the second end core piece 33s. The gap material 3g is arranged only between the end surface of the first middle core part 31f and that of the second middle core part 31s in this example. The gap material 3g is not interposed between the end surface of the first side core piece 321 and the inner end surface of the second end core piece 33s and between the end surface of the second side core piece 322 and the inner end surface of the second end core piece 33s. The gap material 3g has a first end surface facing the end surface of the first middle core part 31f and a second end surface facing the end surface of the second middle core part 31s. The inner end surface of the second end core piece 33s has regions respectively facing the end surfaces of the first and second side core pieces 321, 322.

The end surface of the first middle core part 31f and that of the second middle core part 31s are constituted by first surfaces 35. The first and second end surfaces of the gap material 3g are constituted by second surfaces 36. The first surface 35 constituting the end surface of the first middle core part 31f and the first surface 35 constituting the end surface of the second middle core part 31s have, for example, a first region 351 and non-contact regions 352, for example, as shown in FIG. 12 or 13. The second surface 36 constituting the first end surface of the gap material 3g and the second surface 36 constituting the second end surface of the gap material 3g have, for example, a second region 361 and non-contact regions 362, for example, as shown in FIGS. 12 and 13. Note that, although not shown, each first surface 35 may have a first region and contact regions or may have a first region, a non-contact region and a contact region. Each second surface 36 may have a second region and contact regions or may have a second region, a non-contact region and a contact region. The first surface 35 of the first middle core part 31f, the first surface 35 of the second middle core part 31s and the both second surfaces 36 of the gap material 3g can be formed as follows in the manufacturing process of the reactor 1. It is assumed that the gap material 3g is sandwiched between the end surface of the first middle core part 31f and that of the second middle core part 31s. In that state, the first and second core pieces 3f, 3s are pressed toward each other.

<When Non-Magnetic Material as Main Component of Gap Material is Ceramic>

The first region 351 on the first middle core part 31f and the first region 351 on the second middle core part 31s are, for example, formed into flat surfaces as shown in FIG. 12. The second region 361 and the non-contact regions 362 on the first end surface of the gap material 3g are, for example, formed into flat surfaces as shown in FIG. 12. Further, the second region 361 and the non-contact regions 362 on the second end surface of the gap material 3g are, for example, formed into flat surfaces as shown in FIG. 12. The gap material 3g containing a ceramic as the non-magnetic material as a main component is hardly deformed by pressing. Thus, the shapes of the first and second end surfaces of the gap material 3g are easily maintained before and after the manufacturing of the reactor. That is, the surface property of the gap material 3g is transferred to each of the first and second core pieces 3f, 3s in the manufacturing process of the reactor 1.

In this example, the first region 351 on the first middle core part 31f and the first region 351 on the second middle core part 31s easily have different configurations. Further, the second region 361 on the first end surface and the second region 361 on the second end surface of the gap material 3g easily have different configurations. For example, as shown in FIG. 12, a length of the first region 351 on the second middle core part 31s along a second direction D2 tends to be shorter than that of the first region 351 on the first middle core part 31f along the second direction D2. Further, a length of the second region 361 on the second end surface of the gap material 3g along the second direction D2 tends to be shorter than that of the second region 361 on the first end surface along the second direction D2.

The reason for that is that the first and second middle core parts 31f, 31s are made of different materials in this example. The second middle core part 31s contains more soft magnetic powder and is harder than the first middle core part 31f. Thus, the end surface of the second middle core part 31s is less likely to be deformed by pressing in the reactor manufacturing process than the end surface of the first middle core part 31f. Therefore, the shape of the end surface of the second middle core part 31s is more easily maintained before and after the manufacturing of the reactor than the end surface of the first middle core part 31f.

<When Non-Magnetic Material as Main Component of Gap Material is Resin>

The first region 351 on the first middle core part 31f is, for example, formed into a convex shape as shown in FIG. 13, similarly to the first region 351 shown in FIGS. 3, 4 described in the first embodiment. Further, the first region 351 on the second middle core part 31s is, for example, formed into a convex shape as shown in FIG. 13, similarly to the first region 351 shown in FIGS. 3, 4 described in the first embodiment. The tip of the convex first region 351 on the first middle core part 31f and the tip of the convex first region 351 on the second middle core part 31s are, for example, both formed into flat surfaces. The second region 361 on the first end surface and the second region 361 on the second end surface of the gap material 3g are, for example, both formed into concave shapes as shown in FIG. 13 similarly to the second region 361 shown in FIGS. 3 and 4. The bottom surface of the concave second region 361 on the first end surface and the bottom surface of the concave second region 361 on the second end surface are, for example, both formed into flat surfaces. The gap material 3g containing a resin as the non-magnetic material as a main component is easily deformed by pressing in the manufacturing process of the reactor 1. Thus, the shapes of the first and second end surfaces of the gap material 3g are hardly maintained before and after the manufacturing of the reactor 1. That is, the first core piece 3f and the gap material 3g easily transfer the surface properties to each other, and the second core piece 3s and the gap material 3g easily transfer the surface properties to each other.

In this example, the convex first region 351 on the first middle core part 31f and the convex first region 351 on the second middle core part 31s easily have different configurations. Further, the concave second region 361 on the first end surface and the concave second region 361 on the second end surface of the gap material 3g easily have different configurations. For example, as shown in FIG. 13, a projection amount of the first region 351 on the second middle core part 31s tends to be larger than that of the first region 351 on the first middle core part 31f. Moreover, a length of the flat surface of the first region 351 on the second middle core part 31s along the second direction D2 tends to be shorter than that of the flat surface of the first region 351 on the first middle core part 31f along the second direction D2. Further, as shown in FIG. 13, a depth of the second region 361 on the second end surface of the gap material 3g tends to be larger than that of the second region 361 on the first end surface. Moreover, a length of the bottom surface of the second region 361 on the second end surface along the second direction D2 tends to be shorter than that of the bottom surface of the second region 361 on the first end surface along the second direction D2. The reason for that is that the first and second middle core parts 31f, 31s are made of different materials as described above.

Of course, even if the first and second middle core parts 31f, 31s are made of different materials as in this example, the first region 351 on the first middle core part 321f and the first region 351 on the second middle core part 31s may have the same configuration. Further, the second region 361 on the first end surface and the second region 361 on the second end surface of the gap material 3g may have the same configuration.

If the first and second middle core parts 31f, 31s are made of the same material unlike this example, the first region 351 on the first middle core part 321f and the first region 351 on the second middle core part 31s tend to have the same configuration, but may have mutually different configurations. Further, the second region 361 on the first end surface of the gap material 3g and the second region 361 on the second end surface of the gap material 3g tend to have the same configuration, but may have mutually different configurations.

The end surface of the first side core piece 321 and that of the second side core piece 322 are constituted by third surfaces 37 as shown in FIG. 5. The inner end surface of the second end core piece 33s has fourth surfaces 38 without having the second surface. The third surface 37 of this example is similar to the third surface 37 described in the first embodiment. The fourth surface 38 of this example is similar to the fourth surface 38 described in the first embodiment.

[Manufacturing Method]

The reactor 1 of this example can be manufactured through a step similar to that of the aforementioned reactor manufacturing method. In this example, the following requirements (1) and (2) are different from the aforementioned reactor manufacturing method.
(1) In the process A, the separately prepared gap material 3g is interposed in a gap between the first and second core pieces 3f, 3s. Specifically, the gap material 3g is sandwiched by the end surface of the first middle core part 31f and that of the second middle core part 31s.
(2) Although not shown, the end surface of the second middle core part 31s has a convex surface similar to the convex surface of the first middle core part 31f described with reference to FIG. 6 or 7 in the first embodiment.

In this example, the lengths of the first middle core part 31f, the second middle core part 31s, the gap material 3g, the first side core piece 321 and the second side core piece 322 are appropriately adjusted to satisfy the following requirements (a) and (b) after the aforementioned process B.
(a) The end surface of the first side core piece 321 and the inner end surface of the second end core piece 33s are in contact.
(b) The end surface of the second side core piece 322 and the inner end surface of the second end core piece 33s are in contact.

For example, the sum of the length of the first middle core part 31f along the first direction D1, the length of the second middle core part 31s along the first direction D1 and the length of the gap material 3g along the first direction D1 is made longer than each of the length of the first side core piece 321 along the first direction D1 and the length of the second side core piece 322 along the first direction D1.

[Functions and Effects]

The reactor 1 of this example easily obtains a desired inductance similarly to the reactor 1 of the first embodiment even if the gap material 3g is interposed between the first middle core part 31f of the E-shaped first core piece 3f and the second middle core part 31s of the T-shaped second core piece 3s.

### Sixth Embodiment

[Reactor]

A reactor 1 according to the sixth embodiment is described mainly with reference to FIG. 14. The reactor 1 of this example differs from the reactor 1 of the first embodiment in that a coil 2 includes two winding portions 21, 22 and a combination of first and second core pieces 3f, 3s is of a U-U type.

[Coil]

The coil 2 includes two winding portions 21, 22 in the form of quadrilateral tubes. By including the two winding portions 21, 22, the reactor 1 of this example can be shortened in length along axial directions of the winding portions 21, 22 if the winding portions have the same cross-sectional area and the same number of turns as compared to the reactor 1 of the first embodiment including one winding portion 21. The respective winding portions 21, 22 are configured by spirally winding separate winding wires. Each winding wire is as described above.

The two winding portions 21, 22 can be, for example, electrically connected as follows. As in this example, a coupling member 23 independent of the two winding portions 21, 22 is connected to conductors of the winding wires in the two winding portions 21, 22. The coupling member 23 is, for example, constituted by the same member as the winding wires. Alternatively, the conductors of the winding wires in the two winding portions 21, 22 are directly connected. In the case of directly connecting the conductors, an end side of the winding wire in one winding portion 21 may be bent and extended to an end side of the winding wire in the other winding portion 22. The connection of the conductors and the coupling member 23 or the connection of the conductors is performed by welding or insulation displacement. Unlike this example, the two winding portions 21, 22 may be configured by spirally winding one winding wire having no joint part. In that case, the two winding portions 21, 22 are electrically connected via a connecting portion formed by bending a part of the winding wire into a U shape on one end side in an axial direction of the coil 2.

The aforementioned external device is connected to the exposed conductor wires in first end parts 21a, 22a of the winding portions 21, 22. The aforementioned coupling member 23 is connected to the exposed conductor wires in second end parts 21b, 22b of the winding portions 21, 22.

[Magnetic Core]

The magnetic core 3 includes a first middle core piece 311, a second middle core piece 312, a first end core piece 33f and a second end core piece 33s. In the magnetic core 3, a direction along the axial directions of the winding portions 21, 22 is a first direction D1, a parallel direction of the first and second middle core piece 311, 312 is a second direction D2 and a direction orthogonal to both the first and second directions D1, D2 is a third direction D3.

(First Middle Core Piece, Second Middle Core Piece)

The first middle core piece 311 has a part to be arranged inside the winding portion 21. The second middle core piece 312 has a part to be arranged inside the winding portion 22. The first and second middle core pieces 311, 312 are shaped to correspond to the inner peripheral shapes of the winding portions 21, 22 and in the form of rectangular columns in this example.

The first middle core piece 311 is, for example, composed of two core parts including a first middle core part 311f and a first middle core part 311s as in this example and the like. Further, the first middle core piece 311 may be composed of one core part as in the ninth embodiment shown in FIG. 17 and the like. The second middle core piece 312 is, for example, composed of two core parts including a second middle core part 312f and a second middle core part 312s as in this example and the like. Further, the second middle core piece 312 may be composed of one core part as in the ninth embodiment and the like.

A length of the first middle core piece 311 along the first direction D1 and that of the second middle core piece 312 along the first direction D1 are equal to each other. The length of the first middle core piece 311 along the first direction D1 and that of the second middle core piece 312 along the first direction D1 are equivalent to lengths of the winding portions 21, 22 along the axial directions. The length of the first middle core piece 311 along the first direction D1 and that of the second middle core piece 312 along the first direction D1 include a length Lg of a gap material 3g along the first direction D1 if the gap material 3g to be described later is disposed. The length of the first middle core piece 311 along the first direction D1 is the sum (L11f+L11s) of a length L11f of the first middle core part 311f and a length L11s of the first middle core part 312s. The length of the second middle core piece 312 along the first direction D1 is the sum (L12f+L12s) of a length L12f of the second middle core part 312f and a length L12s of the second middle core part 312s. A length of the first middle core piece 311 along the second direction D2 and that of the second middle core piece 312 along the second direction D2 are equal to each other. A length of the first middle core piece 311 along the third direction D3 and that of the second middle core piece 312 along the third direction D3 are equal to each other.

(First End Core Piece, Second End Core Piece)

The first end core piece 33f is facing both one end part of the winding portion 21 and one end part of the winding portion 22. The second end core piece 33s is facing both the other end part of the winding portion 21 and the other end part of the winding portion 22.

A length of the first end core piece 33f along the third direction D3 and that of the second end core piece 33s along the third direction D3 are equal to each other. The length of the first end core piece 33f along the third direction D3 and that of the second end core piece 33s along the third direction D3 are equal to the length of the first middle core piece 311 along the third direction D3 and that of the second middle core piece 312 along the third direction D3. The length of the first end core piece 33f along the third direction D3 and that of the second end core piece 33s along the third direction D3 may be longer than the length of the first middle core piece 311 along the third direction D3 and that of the second middle core piece 312 along the third direction D3.

(Combination)

The magnetic core 3 is a set obtained by combining two core pieces including the first and second core pieces 3f, 3s in the axial directions of the winding portion 21. The shapes of the first and second core pieces 3f, 3s may be symmetrical, but are preferably asymmetrical as described above. In this example, the shape of the first core piece 3f and that of the second core piece 3s are asymmetrical. A combination of the first and second core pieces 3f, 3s is of a U-U type in this example. This combination may be of the U-I type as in the seventh embodiment. These combinations enable easier adjustment of an inductance and heat dissipation. Further, since the reactor 1 can be constructed by combining the first and second core pieces 3f, 3s with the winding portions 21, 22 along the axial directions of the winding portions 21, 22, manufacturing workability is excellent.

(First Core Piece, Second Core Piece)

The first core piece 3f is U-shaped. The first core piece 3f is an integrated compact of the first end core piece 33f, the first middle core part 311f and the second middle core part 312f. The first core piece 3f is constitute by a compact of a composite material as in the first embodiment. The first end core piece 33f links the first and second middle core parts 311f, 312f. The first and second middle core parts 311f, 312f are provided on both ends of the first end core piece 33f. The lengths L11f, L12f are equal to each other.

The second core piece 3s is U-shaped. The second core piece 3s is an integrated compact of the second end core piece 33s, the first middle core part 311s and the second middle core part 312s. The second core piece 3s is constituted by a powder compact as in the first embodiment. The second end core piece 33s links the first and second middle core parts 311s, 312s. The first and second middle core parts 311s, 312s are provided on both ends of the second end core piece 33s. The lengths L11s, L12s are equal to each other.

The lengths L11s, L12s are shorter than the lengths L11f, L12f. Unlike this example, the lengths L11s, L12s and the lengths L11f, L12f may be equal.

The end surface of the first middle core part 311f and that of the first middle core part 311s are facing each other. The end surface of the second middle core part 312f and the end surface of the second middle core part 312s are facing each other.

At least one of the end surface of the first middle core part 311f and that of the second middle core part 312f is constituted by a first surface 35. Out of the end surface of the first middle core part 311s and that of the second middle core part 312s, the end surface facing the first surface 35 is constituted by a second surface 36.

Each end surface in this example is as follows. The end surface of the first middle core part 311f and that of the second middle core part 312f are constituted by first surfaces similar to the first surface 35 shown in FIG. 3 or 4 described in the first embodiment. The end surface of the first middle core part 311s and that of the second middle core part 312s are constituted by second surfaces similar to the second surface 36 shown in FIG. 3 or 4. The magnetic core 4 of this example has no third surface and no fourth surface.

Unlike this example, the magnetic core 3 may have a third surface and a fourth surface as described below. One of the end surface of the first middle core part 311f and that of the second middle core part 312f is constituted by the first surface 35, and the other end surface is constituted by the third surface. The end surface facing the first surface 35, out of the end surface of the first middle core part 311s and that of the second middle core part 312s, is constituted by the second surface 36, and the end surface facing the third surface is constituted by the fourth surface.

[Functions and Effects]

The reactor 1 of this example easily obtains a desired inductance similarly to the reactor 1 of the first embodiment even if the combination of the first and second core piece 3f, 3s is of the U-U type. This is because dimensional tolerances of the first and second side core pieces 321, 322 of the reactor 1 of this example are absorbed in the reactor manufacturing process similarly to the reactor 1 of the first embodiment. Thus, the end surface of the first middle core part 311f and that of the first middle core part 311s are accurately combined, and the end surface of the second middle core part 312f and that of the second middle core part 312s are accurately combined. That is, unnecessary intervals are less likely to be provided between the end surface of the first middle core part 311f and that of the first middle core part 311s and between the end surface of the second middle core part 312f and that of the second middle core part 312s.

### Seventh Embodiment

[Reactor]

A reactor 1 according to the seventh embodiment is described mainly with reference to FIG. 1. The reactor 1 of this example differs from the sixth embodiment in that a combination of first and second core pieces 3f, 3s is of an U-I type. The following description is centered on points of difference from the sixth embodiment. Components similar to those of the sixth embodiment may not be described. This way of description applies also to the eighth and ninth embodiments to be described later.

[Magnetic Core]

(First Core Piece, Second Core Piece)

The first core piece 3f is U-shaped. The first core piece 3f is an integrated compact of a first end core piece 33f, a first middle core piece 311 and a second middle core piece 312. A length L1 of the first middle core piece 311 along the first direction D1 and a length L12 of the second middle core piece 312 along the first direction D1 are equal. The second core piece 3s is I-shaped. The second core piece 3s is constituted by a second end core piece 33s. The inner end surface of the second end core piece 33s has regions respectively facing the end surface of the first middle core piece 311 and that of the second middle core piece 312.

At least one of the end surface of a first middle core part 311f and that of a second middle core part 312f is constituted by a first surface 35. A part of the inner end surface of the second end core piece 33s facing the first surface 35 is constituted by a second surface 36.

Each end surface in this example is as follows. The end surface of the first middle core piece 311 and that of the second middle core piece 312 are constituted by first surfaces similar to the first surface 35 shown in FIG. 3 or 4 described in the first embodiment. The inner end surface of the second end core piece 33s has two second surfaces similar to the second surface 36 shown in FIG. 3 or 4. The magnetic core 3 of this example has no third surface and no fourth surface.

Unlike this example, the magnetic core 3 may have a third surface and a fourth surface as described below. One of the end surface of the first middle core piece 311 and that of the second middle core piece 312 is constituted by the first surface 35, and the other end surface is constituted by the third surface. A part of the inner end surface of the second end core piece 33s facing the first surface 35 is constituted by the second surface 36 and a part facing the third surface is constituted by the fourth surface.

[Functions and Effects]

The reactor 1 of this example easily obtains a desired inductance similarly to the reactor 1 of the sixth embodiment even if the combination of the first and second core piece 3f, 3s is of the U-I type. This is because dimensional tolerances of the first and second middle core pieces 311, 312 of the reactor 1 of this example are absorbed in the reactor manufacturing process similarly to the reactor 1 of the first embodiment. Thus, the end surface of the first middle core piece 311 and that of the second middle core piece 312 are accurately combined with the inner end surface of the second end core piece 33s. That is, unnecessary intervals are less likely to be provided between the end surfaces of the first and second middle core pieces 311, 312 and the inner end surface of the second end core piece 33s.

### Eighth Embodiment

[Reactor]

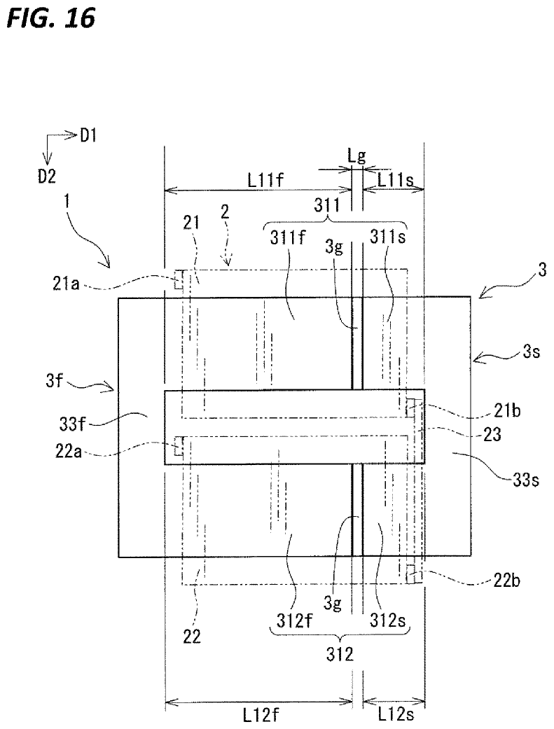

A reactor 1 according to the eighth embodiment is described mainly with reference to FIG. 16. The reactor 1 of this example differs from the reactor 1 of the sixth embodiment in including gap materials 3g interposed between first and second core pieces 3f, 3s. A constituent material of the gap material 3g of this example is similar to that of the gap material 3g of the fifth embodiment.

[Magnetic Core]

(Gap Material)

The gap material 3g may be arranged in at least one of gaps between a first middle core part 311f of the first core piece 3f and a first middle core part 311s of the second core piece 3s and between a second middle core part 312f of the first core piece 3f and a second middle core part 312s of the second core piece 3s. The gap materials 3g of this example are arranged in both of the above two gaps.

The end surface of the first middle core part 311f and that of the second middle core part 312f are constituted by first surfaces similar to the first surface 35 shown on a left side of FIG. 12 or 13 described in the fifth embodiment. The end surface of the first middle core part 311s and that of the second middle core part 312s are constituted by first surfaces similar to the first surface 35 shown on a right side of FIG. 12 or 13. In the gap material 3g between the first middle core parts 311f and 311s, a first end surface on the side of the first middle core part 311f is constituted by a second surface similar to the second surface 36 shown on the left side of FIG. 12 or 13. In the gap material 3g between the first middle core parts 311f and 311s, a second end surface on the side of the first middle core part 311s is constituted by a second surface similar to the second surface 36 shown on the right side of FIG. 12 or 13. In the gap material 3g between the second middle core parts 312f and 312s, a first end surface on the side of the second middle core part 312f is constituted by a second surface similar to the second surface 36 shown on the left side of FIG. 12 or 13. In the gap material 3g between the second middle core parts 312f and 312s, a second end surface on the side of the second middle core part 312s is constituted by a second surface similar to the second surface 36 shown on the right side of FIG. 12 or 13.

[Functions and Effects]

The reactor 1 of this example easily obtains a desired inductance similarly to the reactor 1 of the sixth embodiment even if the gap materials 3g are interposed between the respective first and second middle core parts 311f, 312f of the U-shaped first core piece 3f and the respective first and second middle core parts 311s, 312s of the U-shaped second core piece 3s.

### Ninth Embodiment

[Reactor]

A reactor 1 according to the ninth embodiment is described mainly with reference to FIG. 17. The reactor 1 of this example differs from the reactor 1 of the sixth embodiment in that a magnetic core 3 is a set obtained by combining four I-shaped core pieces.

[Magnetic Core]

The magnetic core 3 is constituted by a compact in which each of a first middle core piece 311, a second middle core piece 312, a first end core piece 33f and a second end core piece 33s is independent. In this example, the first and second middle core pieces 311, 312 are constituted by compacts of a composite material, and the first and second end core pieces 33f, 33s are constituted by powder compacts. Unlike this example, the first and second middle core pieces 311, 312 may be constituted by powder compacts, and the first and second end core pieces 33f, 33s may be constituted by compacts of a composite material.

The inner end surface of the first end core piece 33f has regions respectively facing one end surface of the first middle core piece 311 and one end surface of the second middle core piece 312. The inner end surface of the second end core piece 33s has regions respectively facing the other end surface of the first middle core piece 311 and the other end surface of the second middle core piece 312.

The one and other end surfaces of the first middle core piece 311 and those of the second middle core piece 312 are constituted by first surfaces similar to the first surface 35 shown in FIG. 3 or 4 described in the first embodiment. Each of the inner end surface of the first end core piece 33f and that of the second end core piece 33s has two second surfaces similar to the second surface 36 shown in FIG. 3 or 4.

Alternatively, each of the inner end surface of the first end core piece 33f and that of the second end core piece 33s has two first surfaces similar to the first surface 35 shown in FIG. 3 or 4. The one and other end surfaces of the first middle core piece 311 and those of the second middle core piece 312 are constituted by second surfaces similar to the second surface 36 shown in FIG. 3 or 4.

In either case, the magnetic core 3 of this example has no third surface and no fourth surface.

[Functions and Effects]

The reactor 1 of this example easily obtains a desired inductance similarly to the reactor 1 of the sixth embodiment even if the magnetic core 3 is a set obtained by combining four core pieces.

### Tenth Embodiment

[Reactor]

A reactor 1 according to the tenth embodiment is described mainly with reference to FIG. 18. The reactor 1 of this example differs from the reactor 1 of the ninth embodiment in including gap materials 3g interposed in at least one of gaps between adjacent core pieces. The following description is centered on points of difference from the ninth embodiment. Components similar to those of the ninth embodiment may not be described. A constituent material of the gap materials 3g of this example is similar to that of the gap material 3g of the fifth embodiment.

[Magnetic Core]

(Gap Material)

The gap material 3g is arranged in at least one of gaps between a first middle core piece 311 and a first end core piece 33f, between the first middle core piece 311 and a second end core piece 33s, between a second middle core piece 312 and the first end core piece 33f and between the second middle core piece 312 and the second end core piece 33s. The gap materials 3g are arranged in all of the four gaps in this example.

One and the other end surfaces of the first middle core piece 311 and those of the second middle core piece 312 are constituted by first surfaces similar to the first surface 35 shown on the left side of FIG. 12 or 13 described in the fifth embodiment. Each of the inner end surface of the first end core piece 33f and that of the second end core piece 33s has two first surfaces similar to the first surface 35 shown on the right side of FIG. 12 or 13. A first end surface of each gap material 3g on the middle core piece side is constituted by a second surface similar to the second surface 36 shown on the left side of FIG. 12 or 13. A second end surface of each gap material 3g on the end core piece side is constituted by a second surface similar to the second surface 36 shown on the right side of FIG. 12 or 13.

[Functions and Effects]

The reactor 1 of this example easily obtains a desired inductance similarly to the reactor 1 of the sixth embodiment even if the magnetic core 3 is a set obtained by combining four core pieces and the gap materials 3g are interposed in all the gaps between the adjacent core pieces.

### Eleventh Embodiment

[Converter, Power Conversion Device]

The reactors 1 of the first to tenth embodiments can be used in an application satisfying the following energizing conditions. The energizing conditions include, for example, a maximum direct current of about 100 A or more and 1000 A or less, an average voltage of about 100 V or more and 1000 V or less and a use frequency of about 5 kHz or more and 100 kHz or less. The reactor 1 of the first embodiment and the like can be typically used as a constituent component of a converter to be installed in a vehicle such as an electric or hybrid vehicle and a constituent component of a power conversion device provided with this converter.

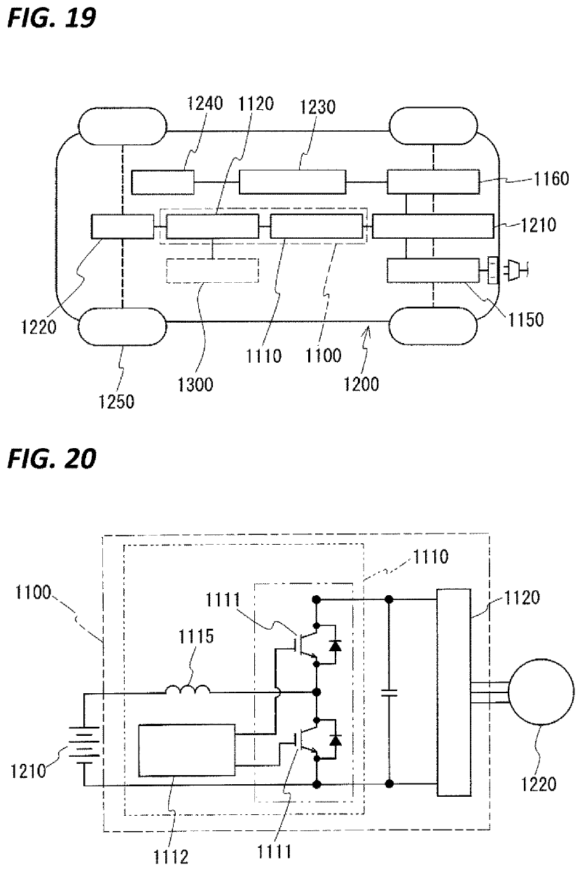

A vehicle 1200 such as a hybrid or electric vehicle is, as shown in FIG. 19, provided with a main battery 1210, a power conversion device 1100 connected to the main body 1210 and a motor 1220 used for travel by being driven by power supplied from the main body 1210. The motor 1220 is, typically, a three-phase alternating current motor and has a function of driving wheels 1250 during travel and a function as a generator during regeneration. In the case of a hybrid vehicle, the vehicle 1200 includes an engine 1300 in addition to the motor 1220. FIG. 19 shows an inlet as a charging point of the vehicle 1200, but the vehicle 1200 can include a plug.

The power conversion device 1100 includes a converter 1110 to be connected to the main battery 1210 and an inverter 1120 connected to the converter 1110 for the mutual conversion of a direct current and an alternating current. The converter 1110 shown in this example steps up an input voltage of the main battery 1210 of about 200 V or more and 300 V or less to about 400 V or more and 700 V or less and supplies the stepped-up voltage to the inverter 1120 during the travel of the vehicle 1200. The converter 1110 steps down an input voltage output from the motor 1220 via the inverter 1120 to a direct-current voltage suitable for the main battery 1210 and charges the direct-current voltage to the main battery 1210 during regeneration. The input voltage is a direct-current voltage. The inverter 1120 converts the direct current stepped up by the converter 1110 into a predetermined alternating current and supplies the converted current to the motor 1220 during the travel of the vehicle 1200 and converts an alternating current from the motor 1220 into a direct current and outputs the direct current to the converter 1110 during regeneration.

The converter 1110 includes a plurality of switching elements 1111, a drive circuit 1112 for controlling the operation of the switching elements 1111 and a reactor 1115 as shown in FIG. 20, and converts an input voltage by being repeatedly turned on and off. The conversion of the input voltage means voltage step-up and -down here. A power device such as a field effect transistor or an insulated gate bipolar transistor is used as the switching element 1111. The reactor 1115 has a function of smoothing a change of a current when the current is increased or decreased by a switching operation, using a property of a coil to hinder a change of a current flowing into a circuit. The reactor 1115 includes the reactor 1 of the first embodiment or the like. By including the reactor 1 in which the plurality of core pieces constituting the magnetic core 3 are accurately combined with ease, an improvement in the productivity of the power conversion device 1100 and the converter 1110 can be expected.

Besides the converter 1110, the vehicle 1200 is provided with a power supply device converter 1150 connected to the main battery 1210 and an auxiliary power supply converter 1160 connected to a sub-battery 1230 serving as a power source of auxiliary devices and the main battery 1210 and configured to convert a high voltage of the main battery 1210 into a low voltage. The converter 1110 typically performs DC-DC conversion, but the power supply device converter 1150 and the auxiliary power supply converter 1160 perform AC-DC conversion. The power supply device converter 1150 may perform DC-DC conversion. Reactors configured similarly to the reactor 1 of the first embodiment and the like and appropriately changed in size, shape and the like can be used as reactors of the power supply device converter 1150 and the auxiliary power supply converter 1160. Further, the reactor 1 of the first embodiment and the like can also be used as a converter for converting input power and only stepping up or only stepping down a voltage.

The present invention is not limited to these illustrations and is represented by claims and intended to include all changes in the scope of claims and in the meaning and scope of equivalents.

For example, in the reactor according to the first embodiment, the combination of the first and second core pieces may be of an F-F type, an F-L type or a U-T type.

(F-F Type)

A first core piece is an integrated compact of a first end core piece, a part of a middle core piece and an entire first side core piece. A second core piece is an integrated compact of a second end core piece, a remaining part of the middle core piece and an entire second side core piece. At least one of the inner end surface of the first end core piece 33f of the first core piece, the end surface of a first middle core part, which is the part of the middle core piece, and the end surface of the first side core piece is constituted by a first surface. The end surface facing the first surface, out of the inner end surface of the second end core piece, the end surface of a second middle core part, which is the remaining part of the middle core piece, and the end surface of the second side core piece, is constituted by a second surface.

(F-L Type)

A first core piece is an integrated compact of a first end core piece, an entire middle core piece and an entire first side core piece. A second core piece is an integrated compact of a second end core piece and an entire second side core piece. At least one of the inner end surface of the first end core piece, the end surface of the middle core piece and the end surface of the first side core piece is constituted by a first surface. The end surface facing the first surface, out of the inner end surface of the second end core piece and the end surface of the second side core piece, is constituted by a second surface.

(U-T Type)

A first core piece is an integrated compact of a first end core piece, an entire first side core piece and an entire second side core piece. A second core piece is an integrated compact of a second end core piece and an entire middle core piece. At least one of the inner end surface of the first end core piece, the end surface of the first side core piece and the end surface of the second side core piece is constituted by a first surface. The end surface facing the first surface, out of the inner end surface of the second end core piece and the end surface of the middle core piece, is constituted by a second surface.

In the reactor according to the sixth embodiment, the combination of the first and second core pieces may be of a J-L type, a J-J type or an L-L type.

(J-L Type)

A first core piece is an integrated compact of a first end core piece, an entire first middle core piece and a part of a second middle core piece. A second core piece is an integrated compact of a second end core piece and a remaining part of the second middle core piece. At least one of the end surface of the first middle core piece and the end surface of a second middle core part, which is the part of the second middle core piece, is constituted by a first surface. The end surface facing the first surface, out of the inner end surface of the second end core piece and the end surface of a second middle core part as the remaining part of the second middle core piece, is constituted by a second surface.

(J-J Type)

A first core piece is an integrated compact of a first end core piece, a part of a first middle core piece and a part of a second middle core piece. Lengths of the part of the first middle core piece and the part of the second middle core piece in the first core piece along the first direction are different from each other. A second core piece is an integrated compact of a second end core piece, a remaining part of the first middle core piece and a remaining part of the second middle core piece. At least one of the end surface of a first middle core part, which is the part of the first middle core piece, and the end surface of a second middle core part, which is the part of the second middle core piece, is constituted by a first surface. The end surface facing the first surface, out of the end surface of a first middle core part as the remaining part of the first middle core piece and the end surface of a second middle core part as the remaining part of the second middle core piece, is constituted by a second surface.

(L-L Type)

A first core piece is an integrated compact of a first end core piece and an entire first middle core piece. A second core piece is an integrated compact of a second end core piece and an entire second middle core piece. At least one of the inner end surface of the first end core piece and the end surface of the first middle core piece is constituted by a first surface. The end surface facing the first surface, out of the inner end surface of the second end core piece and the end surface of the second middle core piece, is constituted by a second surface.

### LIST OF REFERENCE NUMERALS

1 reactor
2 coil, 21, 22 winding portion
21a, 21a first end part, 21b, 22b second end part
23 coupling member
3 magnetic core, 3f first core piece, 3s second core piece
31 middle core piece
31f first middle core part, 31s second middle core part
311 first middle core piece
311f first middle core part, 311s first middle core part
312 second middle core piece
312f second middle core part, 312s second middle core part
321 first side core piece
321f first side core part, 312s second side core part
322 second side core piece
322f second side core part, 322s second side core part
33f first end core piece, 33s second end core piece
3g gap material
first surface
351 first region, 352 non-contact region, 353 contact region
36 second surface
361 second region, 362 non-contact region, 363 contact region
37 third surface, 373 contact region
38 fourth surface, 383 contact region
4 molded resin portion
D1 first direction, D2 second direction, D3 third direction
L1, L1f, L1s length
L11, L11f, L11s length
L12, L12f, L12s length
L21, L21f, L21s length
L22, L22f, L22s length
Lg length
1100 power conversion device, 1110 converter
1111 switching element, 1112 drive circuit
1115 reactor, 1120 inverter
1150 power supply device converter
1160 auxiliary power supply converter
1200 vehicle, 1210 main battery
1220 motor, 1230 sub-battery
1240 auxiliary devices, 1250 wheel, 1300 engine

1. A reactor, comprising:
a coil: and
a magnetic core,
the magnetic core having:
a first surface made of a material mainly containing a magnetic material; and
a second surface made of a material mainly containing a magnetic material,
the first and second surfaces facing each other,
the first surface having:
a first region with a surface property following that of the second surface; and
a contact region in contact with the second surface without having the surface property following that of the second surface,
the second surface having:
a second region with a surface property following that of the first surface; and
a contact region in contact with the contract region of the first surface without having the surface property following that of the first surface, and
the first and second regions being in contact with each other with irregularities on a surface of the first region and irregularities on a surface of the second region fit.

2. The reactor of claim 1, wherein the first surface has a non-contact region arranged apart from the second surface.

3. The reactor of claim 1, wherein:
the coil includes one tubular winding portion,
the magnetic core is a set obtained by combining a first core piece and a second core piece in an axial direction of the winding portion,
the first core piece is E-shaped,
the second core piece is E-shaped, T-shaped, I-shaped or U-shaped,
the first surface is provided on the first core piece, and
the second surface is provided on the second core piece.

4. The reactor of claim 1, wherein:
the coil includes two tubular winding portions,
the two winding portions are so arranged side by side that axial directions are parallel,
the magnetic core is a set obtained by combining a first core piece and a second core piece in the axial directions of the winding portions,
the first core piece is U-shaped,
the second core piece is U-shaped or I-shaped,
the first surface is provided on the first core piece, and
the second surface is provided on the second core piece.

5. The reactor of claim 3, wherein:
the first and second core pieces respectively have a third surface and a fourth surface facing each other, and
the third and fourth surfaces have regions in contact with each other without each having a surface property following that of the other.

6. The reactor of claim 3, wherein
the first core piece is constituted by a compact of a composite material, a soft magnetic powder being dispersed in a resin in the composite material, and
the second core piece is constituted by a powder compact containing a soft magnetic powder.

7. The reactor of claim 1, wherein:
the coil includes at least one tubular winding portion, and
the magnetic core is a set obtained by combining three or more core pieces.

8. The reactor of claim 1, comprising a molded resin portion for at least partially covering the magnetic core.

9. A converter, comprising the reactor of claim 1.

10. A power conversion device, comprising the converter of claim 9.

11-16. (canceled)
